(19) United States
(12) Patent Application Publication
(10) Pub. No.: US 2012/0317509 A1
(43) Pub. Date: Dec. 13, 2012

(54) INTERACTIVE WYSIWYG CONTROL OF MATHEMATICAL AND STATISTICAL PLOTS AND REPRESENTATIONAL GRAPHICS FOR ANALYSIS AND DATA VISUALIZATION

(76) Inventors: Lester F. LUDWIG, Belmont, CA (US); Seung E. LIM, Belmont, CA (US)

(21) Appl. No.: 13/357,595

(22) Filed: Jan. 24, 2012

Related U.S. Application Data
(60) Provisional application No. 61/435,395, filed on Jan. 24, 2011.

(51) Int. Cl. G06F 3/048

(52) U.S. Cl. 715/781

(57) ABSTRACT

The invention provides interactive adjustment of plot and data visualization through clicks, rollovers, menus, and other familiar types of rapid user-machine interaction. In an implementation, such interactive adjustments also modify associated software code used to generate the underlying plot or data visualization. In some implementations this feature may be always active. In other embodiments, this feature can be enabled, disabled, overridden, precluded, etc. The invention supports simple mice and their equivalents, advanced mice, gesture-based touch interfaces advanced High-Dimensional Touch Pads and associated touch screens, game controllers, 6D-mice, and extended hyperlink objects. The invention can be implemented in the context of web browsers and spreadsheets, and can be used for Business intelligence, simple plots, and a wide range of data visualization applications. The invention also provides related features to more general programming languages not involved in plots or visualization, allowing programmers on software code and invoke various options via interactive GUIs.

### CROSS-REFERENCE TO RELATED APPLICATIONS

Pursuant to 35 U.S.C. §119(e), this application claims benefit of priority from Provisional U.S. Patent application Ser. No. 61/435,395, filed Jan. 24, 2011, the contents of which are incorporated by reference.

### COPYRIGHT & TRADEMARK NOTICES

A portion of the disclosure of this patent document may contain material, which is subject to copyright protection. Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### FIELD OF THE INVENTION

The present invention pertains to interactive control of visual aspects of mathematical and statistical software, and more specifically to the interactive WYSIWYG (“What You See is What You Get”) control of the rendering of mathematical and statistical plots and representational graphics for analysis and data visualization.

### BACKGROUND OF THE INVENTION

Mathematical analysis programs such as Mathematica™ MatLAB™, R, etc. are used to mathematically model and simulate physical phenomena, analyze measured data, or study purely mathematical phenomena. Such programs are also used as a component within larger-scale CAD systems such as COMSOLTM, etc. Other CAD programs, such as SPICE, may internally include dedicated mathematical evaluation and plotting facilities and capabilities. Each of these broad classes of examples include plotting capabilities, other simple data visualization capabilities involving rendered graphics, and offer some degree of user interactivity. Popular office software programs such as spreadsheets also include modest collections of plotting capabilities. More recently, business intelligence and report “dashboard” software environments such as the open source “Business Intelligence and Reporting Tools” (BIRT) project directed to for rich client and web applications (especially those based on Java and Java EE) have created renewed interest in data visualization for business applications.

Although computers, browsers, and wireless surrogates such as smartphones and tablets are typically operated with a two-dimensional pointing device such as a mouse or simple touch capabilities, data visualization and CAD workstations have historically often been provided with more sophisticated user input devices that provide a higher number of interactive simultaneously-adjustable parameters. Classic examples of this are knob-boxes (as used in HP and SGI workstations), the DataGlove™ (offered by VPL and General Reality), the SpaceBall (and derivative products such as Logitech 3Dconnexion SpaceNavigator™ as well as and associated products from Labtec, HP/Compaq), etc., although few of these have survived product cycles to remain in active use or with wide availability.

More recently enhanced touch-based interfaces have attracted a great deal of attention, mostly for their multi-touch and gesture recognition capabilities. A broader look at advanced user interface technologies providing additional user input beyond the traditional computer mouse or its equivalents (trackpad, trackballs, etc.) include the following:
Introduction of Touch Interfaces in Consumer Electronic Devices and User Experience
Advance Computer Mouse Technology;
HDTP Touch Technology.

For the most part, these advanced user interface technologies have not been advantageously or meaningfully integrated into data visualization environments although they offer great potential (for example as taught in pending U.S. patent application Ser. No. 12/875,128, pending U.S. patent application Ser. No. 12/875,119, and pending U.S. patent application Ser. No. 12/875,115). These advanced user interface technologies are briefly considered in turn in the next three subsections.

### Touch Interfaces in Consumer Electronic Devices and User Experience

Touch interfaces are redefining the user experience and expectations for consumer electronic devices. There are several reasons for this, including:
Users preferring touch interfaces over mechanical buttons
Users welcome and seek new metaphorical touch gestures
The success of touch interface successes stem from providing:
“Natural” gesture metaphors (familiar and intuitive gestures)
Greater ease of use
Greater efficiency
More sophisticated functions and operations
Greater differentiation between actions
Incorporation of additional information (i.e., flick velocity & angle)

### Advance Computer Mouse Technology

Additional adjustable sensors in various mechanical configurations can be added to a conventional computer mouse to provide an additional number simultaneously-adjustable and/or spatially-organized user input variables or parameters. These may include touchpads, trackballs, additional scrollwheels, etc. as taught, for example, in U.S. Pat. No. 7,557,797. These extra sensors can be used to introduce additional interactive control information into the interaction with a computer application. These types of user input devices will be individually referred to as an Advanced Mouse. In some cases the extra adjustable sensors may be simple (such as an extra scroll wheel), moderately sophisticated (such as gesture-responsive touchpad, a joystick providing 3 or more adjustable independent user input variables, a track ball providing 3 or more adjustable independent user input variables, etc.) or may be quite sophisticated, such as including one or more “High Definition Touch Pads” (HDTP), discussed below, or their equivalents.

### HDTP Touch Technology

Enhanced touch-based interfaces such as the HDTP (“High Dimensional Touch Pad,” U.S. Pat. No. 6,570,078; U.S. patent application Ser. No. 11/761,978 and U.S. Ser. No. 12/418,605, among others) employ a tactile sensor array (pressure, proximity, etc.) and real-time image and mathematical processing to provide a powerful user input device with both a higher number of interactive simultaneously-adjustable parameters and a rich range of syntactic and metaphorical capabilities well-suited to use with interactive visualization. Additionally, the HDTP technology can be readily implemented as a touchscreen through use of, for example, inexpensive transparent capacitive proximity-sensor arrays. In various embodiments, HDTP technology can recognize roll, pitch, and yaw angles of an individual finger, multiple simultaneous finger postures and gestures, tactile grammars, multiple-thread operation, and other important features.

Such advance user interface technologies can be used to create extensions of menus and hypermedia objects (hyperlinks, rollovers, buttons, sliders, etc.), for example as taught in pending U.S. Patent application 61/303,898.

Such advance user interface technologies can also be advantageously used to provide interactive features to data visualization and data sonification, for example as taught in pending U.S. patent application Ser. Nos. 12/875,128, 12/875,119, 12/817,074, and 12/817,196.

### Adjustment of Plot and Data Visualization Content

The advanced user interface technologies described in the preceding three subsections, as well as others, can be advantageously and meaningfully integrated into data visualization environments as taught in pending U.S. patent application Ser. No. 12/875,128, pending U.S. patent application Ser. No. 12/875,119, and pending U.S. patent application Ser. No. 12/875,115). Typically these include control over the underlying data content used in creating plots and data visualization—for example, underlying mathematical models, parameters of statistical filers used to process the data, etc.

### Adjustment of Plot and Data Visualization Presentation

Some of the uses of advanced user interface technologies in data visualization environments taught in pending U.S. patent application Ser. No. 12/875,128, pending U.S. patent application Ser. No. 12/875,119, and pending U.S. patent application Ser. No. 12/875,115) also pertains to the presentation of plots and data visualizations, for example ranges of data selected, nonlinear warping of axis scales (for example, log scales)

However, there is much more in the way of interactive control of the presentation of plots and data visualization that can be applied to conventional spreadsheets, dashboards, and data visualization environments such as Mathematica™, MatLab™, etc. Accordingly, the present invention is directed to the interactive WYSIWYG (“What You See is What You Get”) control of the rendering of mathematical and statistical plots and representational graphics for analysis and data visualization.

More specifically, many aspects of plots and visualization have features that are either set by parameters in visualization software (as in the case of Mathematica™, MatLab™, etc.) or adjusted in cumbersome dialog boxes. Neither of these permit rapid optimized adjustment of data presentation nor quick and thorough inspection, study, and interrogation of data and/or models. The present invention specifically addresses these. The invention teaches interactive control of presentation features provided by a simple computer mouse (or its equivalent), a mouse with one or two scroll-wheels, and with the more advanced user interface technologies described earlier (such as gesture-based touch interfaces, advanced mice, and HDTP technologies). The methods and systems can be used in applications such as spreadsheets, browser-based web applications, and modeling/visualization software.

### SUMMARY OF THE INVENTION

For purposes of summarizing, certain aspects, advantages, and novel features are described herein. Not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

In an embodiment, the present invention provides interactive WYSIWYG control of mathematical and statistical plots and representational graphics for analysis and data visualization.

A principle aspect of the present invention is to provide interactive adjustment of plot and data visualization aspects through simple clicks, rollovers, menus, and other familiar types of rapid user-machine interaction

Another principle aspect of the present invention is for such interactive adjustment of plot and data visualization aspects to automatically modify the associated software command or function code used to generate the underlying plot or data visualization. In some embodiments this feature may be always active. In other embodiments, this feature can be enabled, disabled, overridden, precluded, etc.

In an embodiment, the invention provides a method for providing interactive adjustment of plot and data visualization through familiar types of rapid user-machine interaction, the method comprising:

rendering a first graphical representation of provided data on a display screen;

receiving first user interface information from a user interface device;

associating the information with a particular aspect of the graphical representation of provided data;

upon a selection event, directing second user interface information from a user interface device to a graphical rendering function associated with the particular aspect of the graphical representation of data, the graphical rendering function having an existing value;

using the second user interface information to change the existing value of the graphical rendering function to a new value responsive to second user interface information; and

replacing the first graphical representation of provided data on the display screen with a second graphical representation of provided data;

wherein the second graphical representation of provided data is responsive to second user interface information from a user interface device.

In an embodiment, the interactive WYSIWYG control is responsive to user input from a traditional computer mouse or its equivalents (trackpad, trackballs, etc.).

In an embodiment, the interactive WYSIWYG control is responsive to user input from an advance mouse.

In an embodiment, the interactive WYSIWYG control is responsive to user input from a gesture-based touch interface.

In an embodiment, the interactive WYSIWYG control is responsive to user input from an HDTP or equivalent.

In an embodiment, the interactive WYSIWYG control is responsive to user input provided by the roll angle posture of a finger contacting a touch interface.

In an embodiment, the interactive WYSIWYG control is responsive to user input provided by a gesture comprising a roll angle motion of a finger contacting a touch interface.

In an embodiment, the interactive WYSIWYG control is responsive to user input provided by the pitch angle posture of a finger contacting a touch interface.

In an embodiment, the interactive WYSIWYG control is responsive to user input provided by a gesture comprising a pitch angle motion of a finger contacting a touch interface.

In an embodiment, the interactive WYSIWYG control is responsive to user input provided by the yaw angle posture of a finger contacting a touch interface.

In an embodiment, the interactive WYSIWYG control is responsive to user input provided by a gesture comprising a yaw angle motion of a finger contacting a touch interface.

In an embodiment, the interactive WYSIWYG control is responsive to user input provided by a multiple-finger posture of fingers contacting a touch interface.

In an embodiment, the interactive WYSIWYG control is responsive to user input provided by a gesture comprising changes in the multiple-finger contact with a touch interface.

In an embodiment, the interactive WYSIWYG control is responsive to a tactile grammar interpretation of user input provided by at least one finger contacting a touch interface.

In an embodiment, the resultant interactivity is used to reach effective presentation of the data.

In an embodiment, the resultant interactivity is used to explore aspects of the data.

In an embodiment, the interactivity is directed to interactivity attributes within built-in functions comprised by a mathematical programming language.

In an embodiment, the interactivity attributes within built-in functions comprised by a mathematical programming language are not user selectable.

In an embodiment, the interactivity attributes within built-in functions comprised by a mathematical programming language are user selectable.

In an embodiment, the interactivity is directed to specific built-in functions comprised by a mathematical programming language as a result of the user making a menu selection from a menu of options.

In an embodiment, the menu of options comprises a list that is dynamically generated responsive to specific built-in functions used in a user program.

In an embodiment, the interactivity is directed to specific built-in functions comprised by a mathematical programming language as a result of the user clicking-on or rolling-over a portion of a visually-rendered mathematical plot.

In an embodiment, the interactivity is directed to specific built-in functions comprised by a mathematical programming language as a result of the user clicking-on or rolling-over a portion of a visually-rendered data plot.

In an embodiment, the interactivity is directed to specific built-in functions comprised by a mathematical programming language as a result of the user clicking-on or rolling-over a portion of a visually-rendered graphical representation of mathematically-produced data.

In an embodiment, the interactivity is directed to specific built-in functions comprised by a mathematical programming language as a result of the user clicking-on or rolling-over a portion of a visually-rendered graphical representation of measurement data.

In an embodiment, the interactivity is directed to specific built-in functions comprised by a mathematical programming language as a result of the user clicking-on or rolling-over a portion of a visually-rendered graphical representation of mathematically processed measurement data.

In an embodiment, the interactivity is directed to specific built-in functions comprised by a mathematical programming language as a result of the user manipulating a user interface grammar.

In an embodiment, the user interface device interfaces with the mathematical programming language through use of a USB HID device abstraction.

### BRIEF DESCRIPTION OF THE DRAWINGS

The above and other aspects, features and advantages of the present invention will become more apparent upon consideration of the following description of preferred embodiments taken in conjunction with the accompanying drawing and figures.

FIG. 1 depicts various domains to which interactive user control can be directed to mathematical and statistical software and mathematical and statistical plots and representational graphics for analysis and data visualization generated by that software.

FIG. 2a provides a 3D plot of the function sin [x+y²]. in the Mathematica™ programming language,

FIG. 2b calls out the various components of example plot command or function depicted in FIG. 2b.

FIG. 3 depicts an example (two-dimensional array of single-dimension data) data array of the function sin [x+y²] sampled at increments of 0.5 for each of independent x between −3 and 3 and for values of independent y between −2 and 2.

FIGS. 4a-4d show an example user interface experience provided for by the invention wherein the top end of the X-axis range is adjusted from a value of 3 to a value of 8 by a mouse motion.

FIG. 5 depicts an example representation of example actions behind the visual outcomes as provided for by the invention.

FIG. 6 depicts more an an example user experience based on the example comprised by FIGS. 4a-4d.

FIGS. 7a-7c show another example user interface experience provided for by the invention wherein the density of the grid lines of the plot is adjusted.

FIGS. 8a-8c show an example user interface experience provided for by the invention wherein the ratio of the selected dimension is adjusted in each direction in the three-dimensional plot.

FIGS. 9a-9c show an example user interface experience provided for by the invention wherein the density of the sample points is adjusted in a 3D scatter plot.

FIGS. 10a-10c show an example user interface experience provided for by the invention wherein the size of the sample points is adjusted.

FIGS. 11a-11b show an example user interface experience provided for by the invention wherein the display of axes and frame is turned on/off or adjusted.

FIGS. 12a-12c show an example user interface experience provided for by the invention wherein the density of the tick marks is adjusted.

FIGS. 13a-13c show an example user interface experience provided for by the invention wherein the length of the line segments in dashed lines is adjusted.

FIGS. 14a-14c show an example user interface experience provided for by the invention wherein the line thickness of the plot is adjusted.

FIGS. 15a-15c show an example user interface experience provided for by the invention wherein whether the face grid lines are displayed is determined by the state of a checkbox.

FIGS. 16a-16c show an example user interface experience provided for by the invention wherein the line thickness of the face grid lines is adjusted.

FIG. 17 (adapted from pending U.S. patent application Ser. No. 13/026,248) depicts an arrangement for directing high-dimensional input to specific objects in a particular application on a computer or other system.

FIG. 18 (adapted from pending U.S. patent application Ser. No. 13/026,248) depicts what here could be viewed as a variation of FIG. 17 in which the targets of FIG. 17 are extended hyperlink objects, which are referred to as “Multiparameter Hypermedia Objects,” or “MHOs,” in pending U.S. patent application Ser. No. 13/026,248.

FIG. 19 depicts an example flow chart for directing user input to specific plotting, graphics, and/or mathematical functions.

FIG. 20 illustrates an example wherein click-on or roll-over event occurs on a portion of a visually rendered mathematical or data plot.

FIG. 21 illustrates an example wherein click-on or roll-over event occurs on a portion of a visually rendered graphical representation.

FIG. 22 depicts and example adaption of the flow charts depicted in FIG. 20 and FIG. 21 where grammar-based GUIs are used to create environments for user selection and specification.

### DETAILED DESCRIPTION

In the following detailed description, reference is made to the accompanying drawing figures which form a part hereof, and which show by way of illustration specific embodiments of the invention. It is to be understood by those of ordinary skill in this technological field that other embodiments can be utilized, and structural, electrical, as well as procedural changes can be made without departing from the scope of the present invention. Wherever possible, the same element reference numbers will be used throughout the drawings to refer to the same or similar parts.

Some mathematical analysis programs, such as Mathematica™, provide a way to interactively control the value of specific program variables with a user interface device such as a traditional computer mouse (or its equivalents), the Logitech SpaceNavigator 6D input joystick device, or computer game controllers. For the latter two examples, the additional number of user input controls beyond those provided by a computer mouse are handled by the HID feature of the USB interface. In the case of Mathematica, for example, such interactively control the value of specific program variables is provided by the Mathematica Manipulate [.] function.

The present invention differs from this type of capability in that it directs interactive control to built-in aspects of mathematical functions within the mathematical programming language. For example, in an embodiment, the present invention provides interactive WYSIWYG control of mathematical and statistical plots and representational graphics for analysis and data visualization. In particular, user input can be directed to interactive extensions to selected mathematical programming language functions. These allow users to quickly, in interactive rapidly-responsive WYSIWYG fashion so as to, for example:
Interactively experiment with lay-out presentation of graphical objects and plots,
Interactively experiment with visual tools for front-end data-analysis,
Interactively inspect data,
Interactively analyze data.

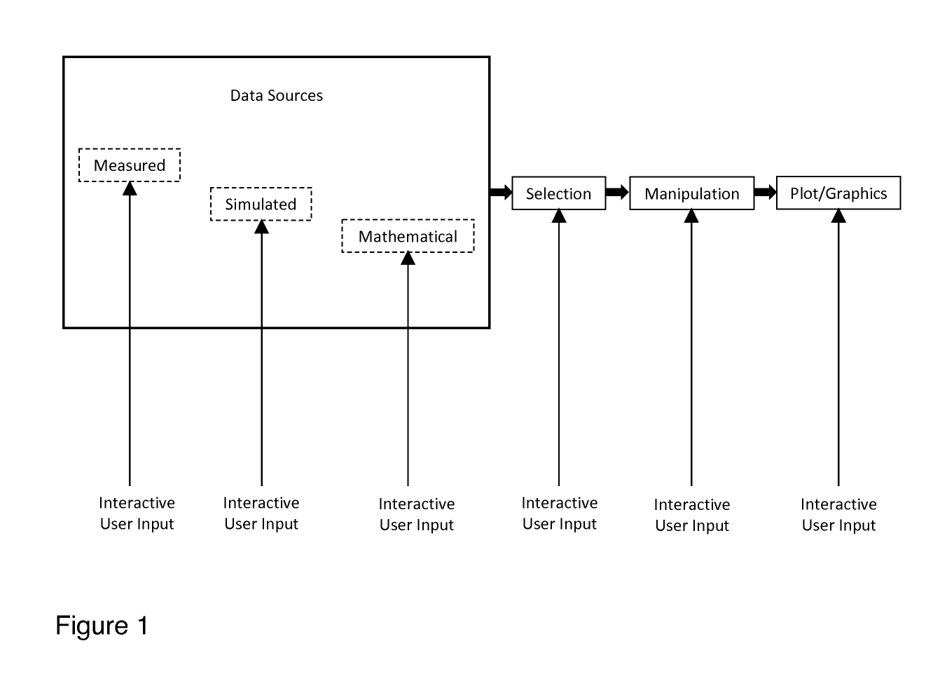

FIG. 1 depicts various domains to which interactive user control can be directed to mathematical and statistical software and mathematical and statistical plots and representational graphics for analysis and data visualization generated by that software.

Some of the use advanced user interface technologies in data visualization environments taught in pending U.S. patent application Ser. No. 12/875,128, pending U.S. patent application Ser. No. 12/875,119, and pending U.S. patent application Ser. No. 12/875,115) also pertains to the presentation of plots and data visualizations, for example ranges of data selected, nonlinear warping of axis scales (for example, log scales)

However, there is much more in the way of interactive control of the presentation of plots and data visualization that can be applied to conventional spreadsheets, dashboards, and data visualization environments such as Mathematica™, MatLab™, etc. Accordingly, the present invention is directed to the interactive WYSIWYG (“What You See is What You Get”) control of the rendering of mathematical and statistical plots and representational graphics for analysis and data visualization.

More specifically, many aspects of plots and visualization have features that are either set by parameters in visualization software (as in the case of Mathematica™, MatLab™, etc.) or adjusted in cumbersome dialog boxes. Neither of these permit rapid optimized adjustment of data presentation nor quick and thorough inspection, study, and interrogation of data and/or models. The present invention specifically addresses these. The invention teaches interactive control of presentation features provided by a simple computer mouse (or its equivalent), a mouse with one or two scroll-wheels, and with the more advanced user interface technologies described earlier (such as gesture-based touch interfaces, advanced mice, and HDTP technologies). The methods and systems can be used in applications such as spreadsheets, browser-based web applications, and modeling/visualization software.

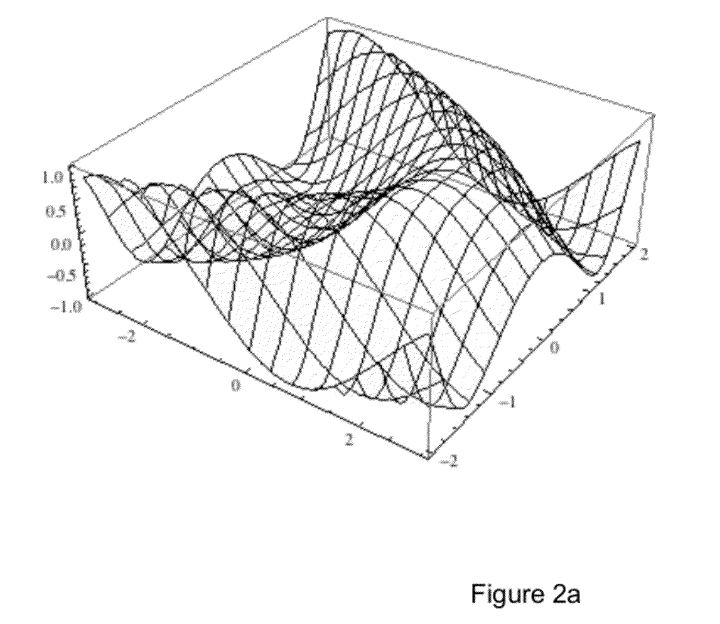

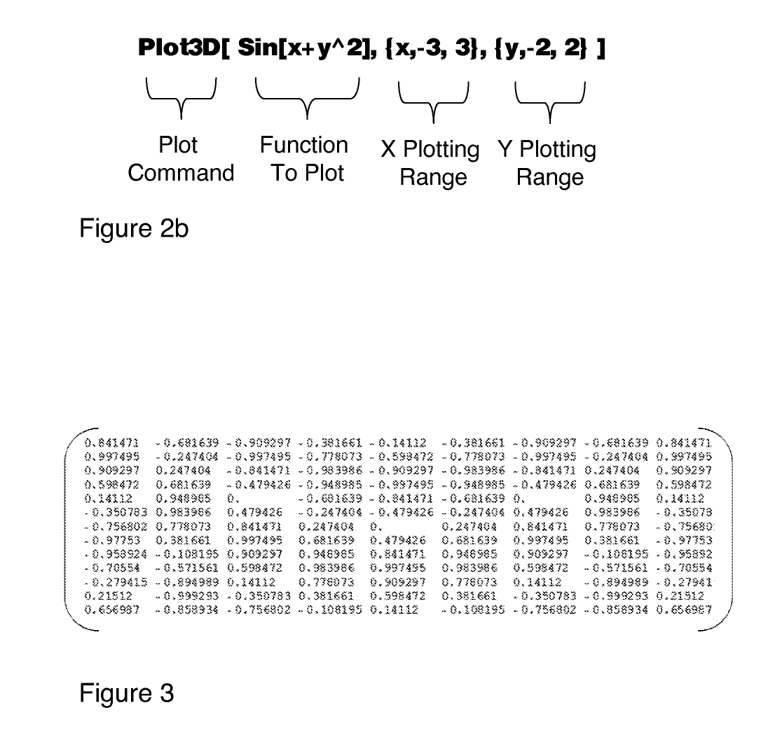

As a starting example, FIG. 2a provides a 3D plot of the function sin[x+y²]. In the Mathematica™ programming language, the plot range for each of the independent variables is specified in the plot command line. In the case depicted in FIG. 2a, the plot is for values of independent x between −3 and 3 and for values of independent y between −2 and 2, and an example of corresponding software code for rendering the plot depicted in FIG. 2a is:
Plot3D[Sin[x+ŷ2],{x,−3,3},{y,−2,2}].
   FIG. 2b calls out the various components of this example plot command, or function including the plot range for each of the two independent variables x and Y.

In this case a mathematical function (here Sin[x+ŷ2]) is directly entered into the plotting command (here the plotting command is Plot3D). This approach is useful for many aspects of mathematical visualizations, and in such cases the function is numerically evaluated as part of the plotting command. However, in more general visualizations one may have data or complicated functions that simply cannot be numerically evaluated as part of the plotting command. For example, the (two-dimensional array of single-dimension data) data array depicted in FIG. 3 corresponds to the function sin[x+y2] sampled at increments of 0.5 for each of independent x between −3 and 3 and for values of independent y between −2 and 2. (As a detail, it is noted that Mathematica uses a different command for plotting arrays of numbers than for plotting pure abstract mathematical functions; for example if the two-dimensional array of single-dimension data array depicted in FIG. 3 is named Fleep, an appropriate command to create a plot resembling that depicted in FIG. 2a is
Plot3D[Fleep]and other operations can be used to adjust the plot range, adjust interpolations between points in the array used to render the surface, etc.

A large number of “display options” can typically be added by the programmer to set many aspects of the plot. In Mathematica, for example, these include options for:
Axis label text: content, spatial location, orientation, and color;
Axis tick mark separations;
Curve label text: content, spatial location, orientation, and color;
Plot label text: content, spatial location, orientation, and color;
Plot size and aspect ratio(s);
Viewpoint location with respect to the plot;
Curve thickness, dashing, and color;
Meshes and mesh density imposed on a rendered surface;
Scatter plot dot density and dot size;
Color and location of lighting sources for illumination of surface-reflected light;
Light properties (opacity, reflectivity, texture, diffusion pattern) of surfaces, curves, text, axes, etc.;
Scale (linear, log, exponential, conformational, etc.)′
Plot fills under and between curves.
   The following example shows how some of these can be applied to the command depicted in FIG. 2b so as to remove the mesh and modify the color in an alternate presentation of the plot depicted in FIG. 2a:
Plot3D[Sin[x+ŷ2],{x,−3,3},{y,−2,2}, Mesh→None, PlotStyle→Directive[Yellow, Specularity[White,20], Opacity[0.8]]]
   Note that, like the plot range, these require modification of the actual software.

Thus, to adjust the plot for inspection, study, fine-tuning, analysis, etc., the visualization user must be proficient in the visualization programming software language and must hand code each plot attempt. A very proficient programmer could, when motivated, selectively hand code in ways to adjust one or more selected targeted aspects of the plot, using for example software functions that implement interactive sliders. This is very cumbersome and highly-inefficient.

It would be better in countless regards to have a way to access interactive adjustment of plot and data visualization aspects through simple clicks, rollovers, menus, and other familiar types of rapid user-machine interaction. A principle aspect of the present invention is to provide interactive adjustment of plot and data visualization aspects through simple clicks, rollovers, menus, and other familiar types of rapid user-machine interaction

Further, in many cases it would be desirable for such interactive adjustment of plot and data visualization aspects to automatically modify the associated software command or function code used to generate the underlying plot or data visualization. Another principle aspect of the present invention is for such interactive adjustment of plot and data visualization aspects to automatically modify the associated software command or function code used to generate the underlying plot or data visualization. In some embodiments this feature may be always active. In other embodiments, this feature can be enabled, disabled, overridden, precluded, etc.

The invention provides for a wide range of interactive adjustments to plot and data visualization aspects, a wide range in the manner in which this is implemented, and a wide range of user interface experiences. A few of these will be presented next by way of illustration. These are only illustrative and are in no way to be construed as limiting.

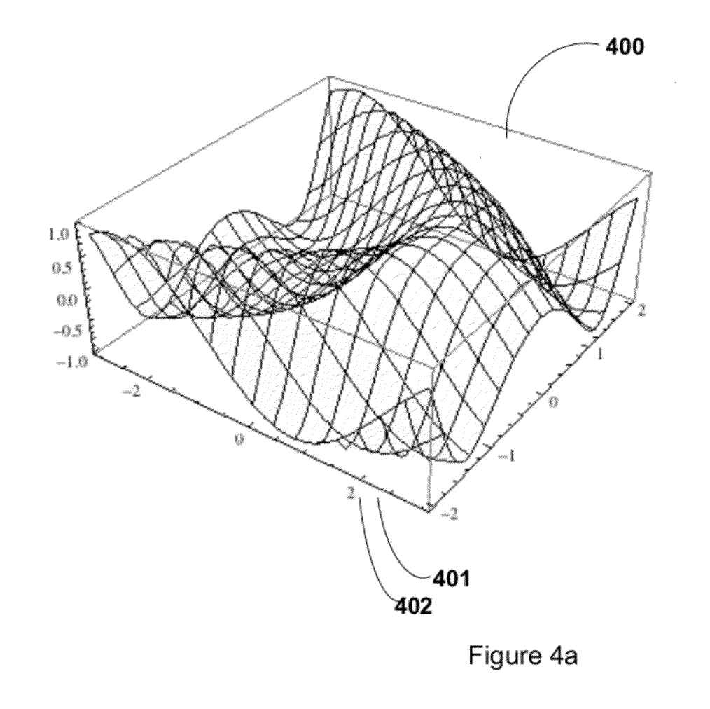

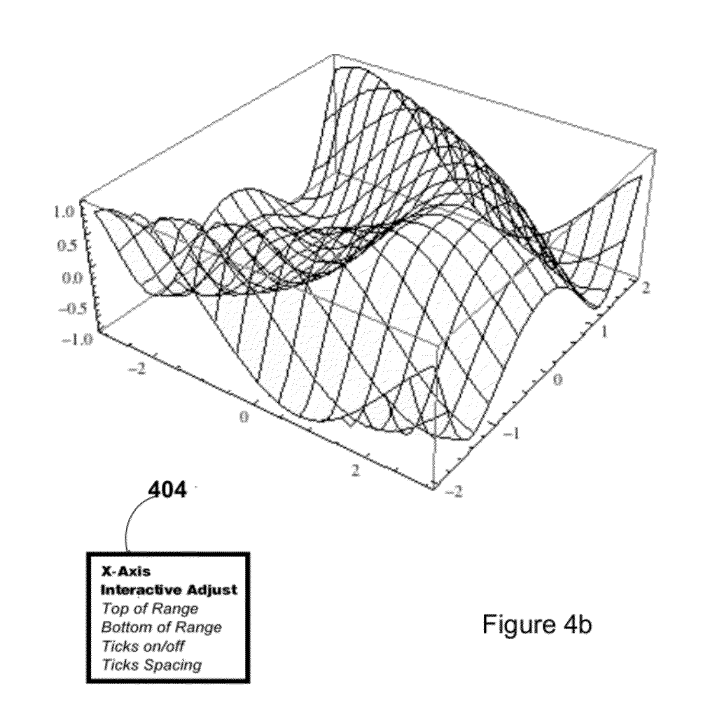

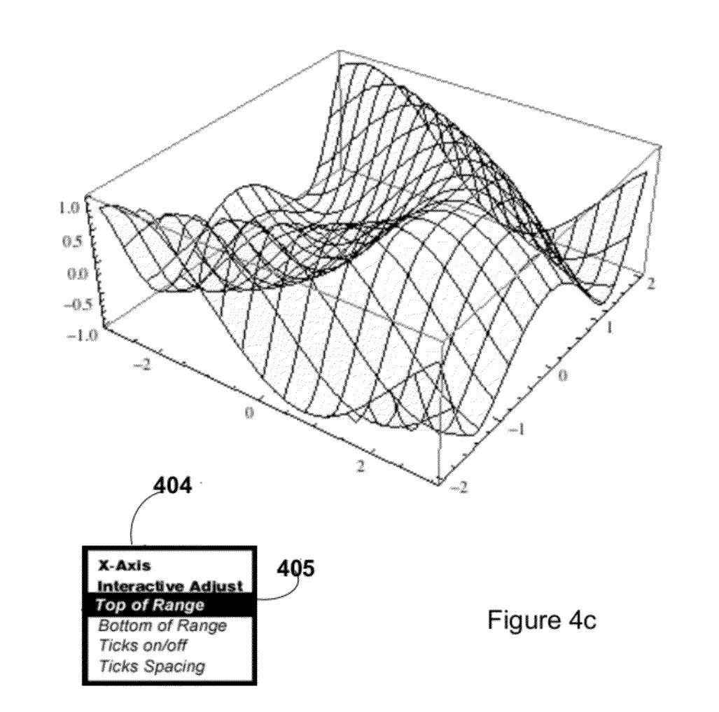

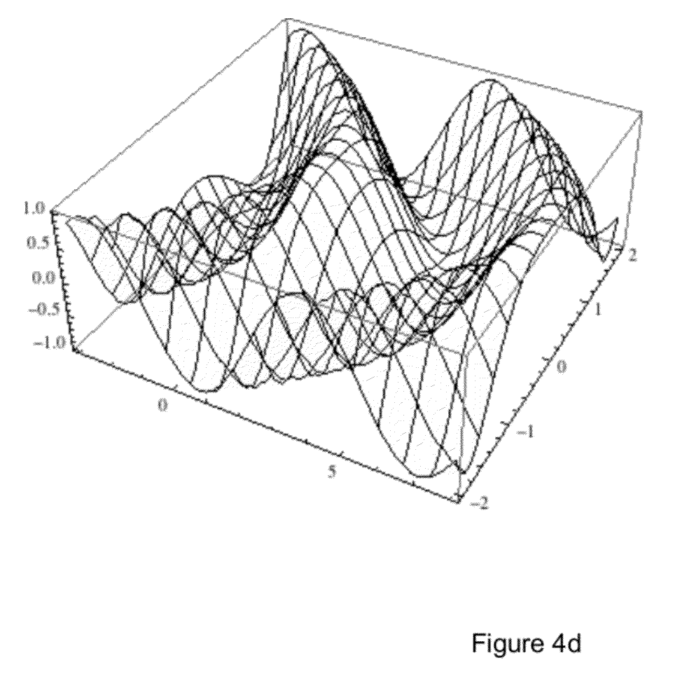

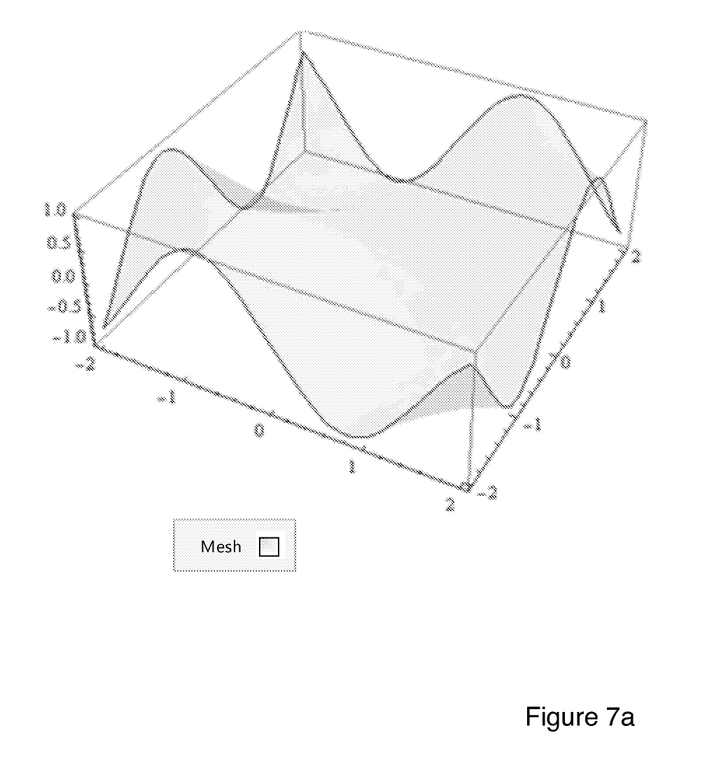

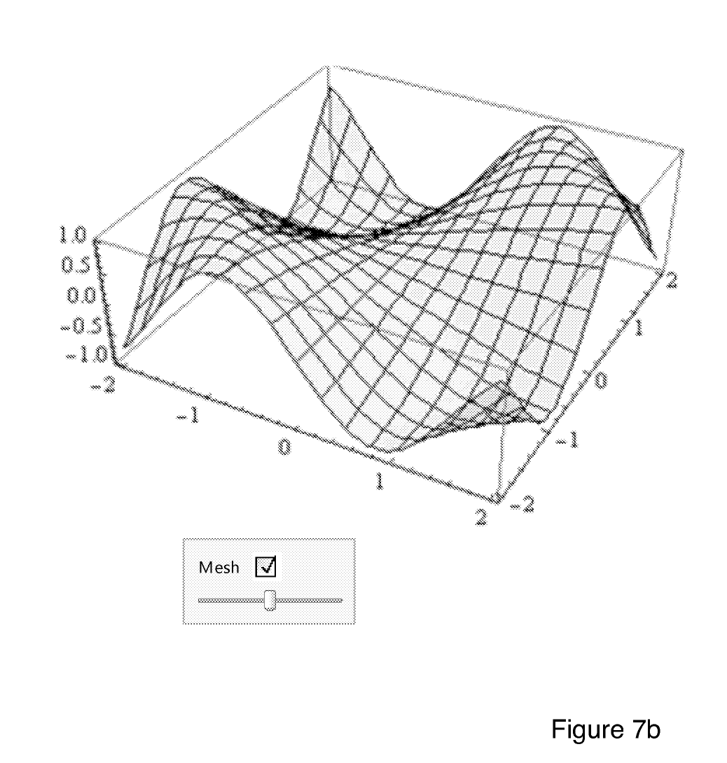

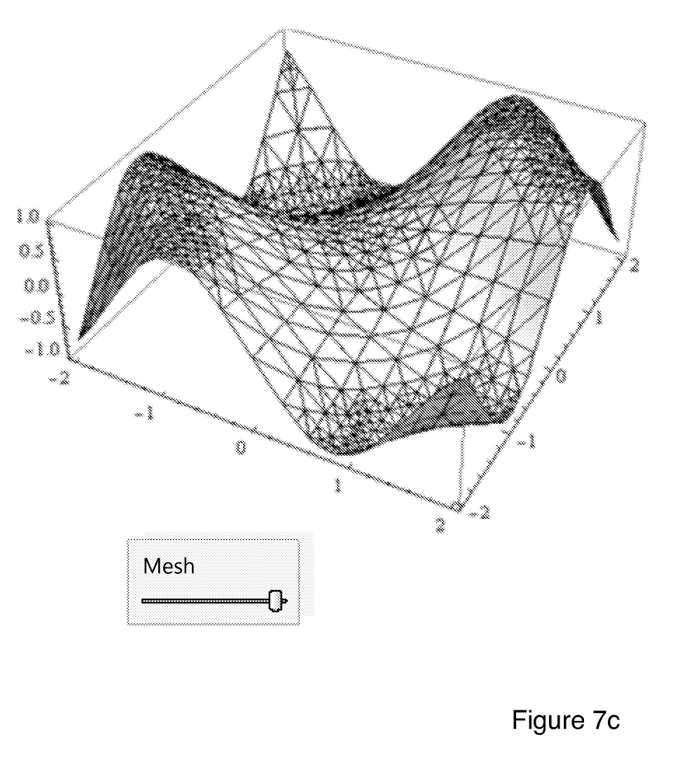

FIGS. 4a-4d show an example user interface experience provided for by the invention wherein the top end of the X-axis range is adjusted from a value of 3 to a value of 8 by a mouse motion. In a variation, by clicking on different portions of the X-axis, the interaction can be simplified and streamlined. As one example, by clicking to the top region of the X-axis the top-range option is automatically selected. In the user interface experience, the step of FIG. 7b can be skipped. The menu would, for example, appear with the default selection already active, but with the menu still provided so as to provide an escape to another interactive adjustment option. As another variation on this example, the interaction can be further simplified and streamlined by skipping the steps of both FIG. 4b and FIG. 4c.

The invention further provides for the inclusion of a simple “undo” function. In some embodiments, the undo function may be single-track, step-by-step undoing each operation in a sequence of recent operations working backwards through the sequence. In another embodiment, the undo function may be multiple-track, distinguished by the function adjusted, and for each function providing a step-by-step undoing each operation in a sequence of recent operations pertaining to that function, working backwards through that sequence. Additionally, the invention provides for higher-levels of undo, for example undoing all actions taken in adjusting a particular function.

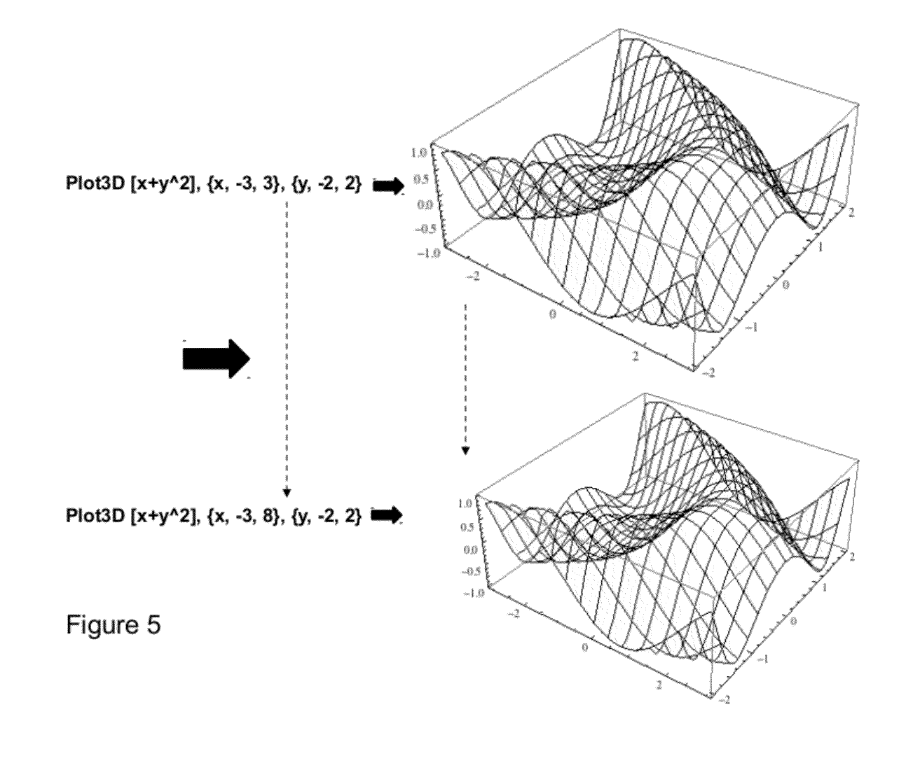

FIG. 5 depicts an example representation of some example actions behind the above visual outcomes as provided for by the invention. In one approach, once the presentation function is selected (in this case, the top range of the X axis), the mouse action adjusts the value of the selected function setting (in this case, the top range of the X plot range) and adjust an entry in the plot command or function (in this case, in the plot range string of the plot command or function). Prior to the mouse action, the value (associated with the plot depicted in FIG. 4a) had a value of 3, while after the mouse action the value (associated with the plot depicted in FIG. 4d) has been changed to a value of 8. The plot command or function with the top range X with a value of 3 is used to render the plot depicted in FIG. 4a, and the plot command or function with the top range X with a value of 8 is used to render the plot depicted in FIG. 4d. In some embodiments such interactive adjustment of plot and data visualization aspects to automatically modify the associated software command or function code used to generate the underlying plot or data visualization as seen by the programmer later when consulting the software again. In some embodiments such interactive adjustment of plot and data visualization aspects to automatically modify the associated software command or function code as currently displayed to the programmer. In some embodiments this feature may be always active. In other embodiments, this feature can be enabled, disabled, overridden, precluded, etc.

Other approaches can be used—for example, the plot can be adjusted without the underlying software being changed, and if the visual presentation change is accepted, the underlying software function code is then adjusted. Other approaches also can be used, for example exploiting real-time control functions such as the Manipulate and Dynamic functions in Mathematica to use as an infrastructure. In the later, these can be temporarily or permanent introduce, and in various embodiments these case be made visible or not made visible to the programmer.

When clicking on a plot or visualization to select a function to interactively modify, or otherwise making the selection (menu, dialog box, etc.), in some cases, the string that is to be modified or overridden is already in the plot command line, for example as described above. In other cases, an entirely new option string must be inserted. For example, starting with the plot command or function used to produce the plot depicted in FIG. 4a
Plot3D[Sin[x+ŷ2],{x,−3,3},{y,−2,2}] various interactive manipulations addressing mesh removal and changes to the surface color rendering would insert the new option string
Mesh→None, PlotStyle→Directive[Yellow, Specularity[White,20], Opacity[0.8]
   near the end of the text string comprising the plot command or function
Plot3D[Sin[x+ŷ2],{x,−3,3},{y,−2,2}]
   so as to result in
Plot3D[Sin[x+ŷ2],{x,−3,3},{y,−2,2}, Mesh→None, PlotStyle→Directive[Yellow, Specularity[White,20], Opacity[0.8]]].

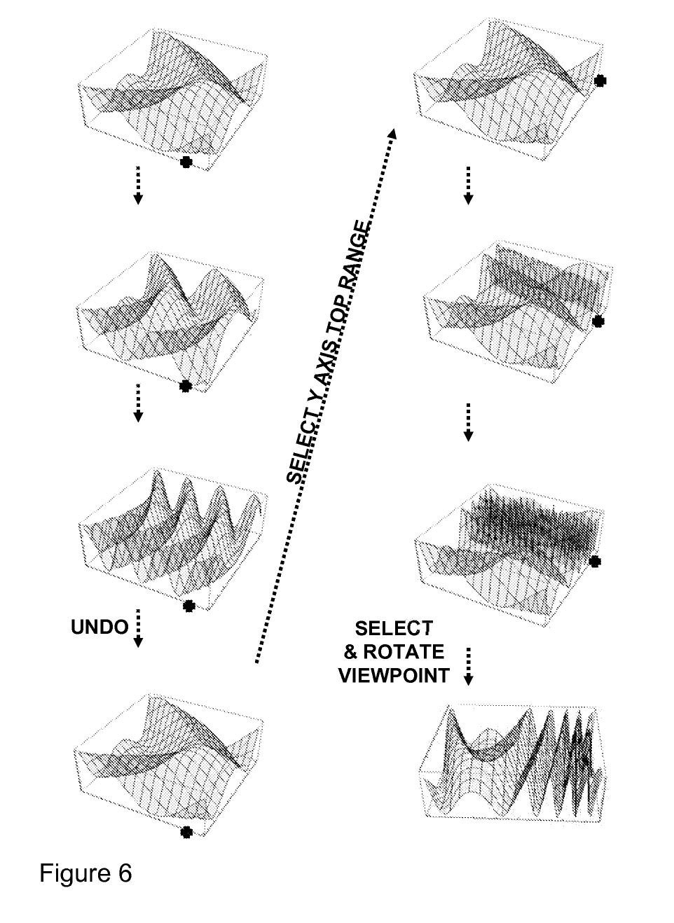

FIG. 6 depicts more an an example user experience based on the example comprised by FIGS. 4a-4d. Here a user (which could be a programmer deep into a data visualization software session or could be a non-programmer just looking at data interactively) could follow a sequence such as:
start with the plot depicted in FIG. 4a,
select the top range of the X axis
adjust the top range of the X axis empirically to a first new value that turns out to be 8 (this is the value the top range of the X axis producing the plot depicted in FIG. 4a);
adjust the top range of the X axis empirically to a first new value that turns out to be 18;
using an undo function (which, depending on options and embodiments can comprise one or two undo action steps) to restore the plot depicted in FIG. 4a,
select the top range of the Y axis
adjust the top range of the Y axis empirically to a first new value that turns out to be 3.5;
adjust the top range of the Y axis empirically to a first new value that turns out to be 5.5;
use an interactive function to change the viewpoint of the later plot so that the surface can be inspected from a different angle.

Some examples of additional steps could also include changing an axis scale to “Log,” changing the color and/or position of the lighting sources “illuminating” the rendered surface, zooming in (via adjustment of several plot range quantities at the same time) to see a particular detail, etc.

FIGS. 7a-7c show another example user interface experience provided for by the invention wherein the density of the grid lines of the plot is adjusted. This example is directed to the interactive control of the mesh drawn upon the rendered plot surface in the 3D plot. Also, as an example variation from the previous example, a dialog box with check-box and slider are employed; however many other interactive means can be used, including a menu-based approach such as that described in conjunction with FIGS. 4a-4d. The slider could be dragged by the mouse, respond to a mouse scroll-wheel, or manipulated in other ways. As shown in FIG. 7a, leaving the “Mesh” checkbox unchecked will keep the mesh lines hidden on the 3D plot. The position of the slider will determine the density of the mesh lines as shown in FIGS. 7b and 7c.

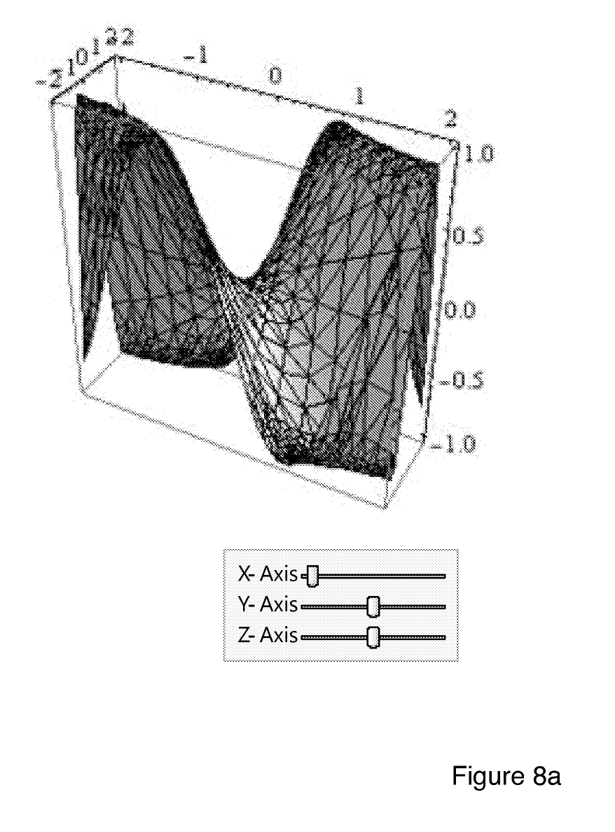

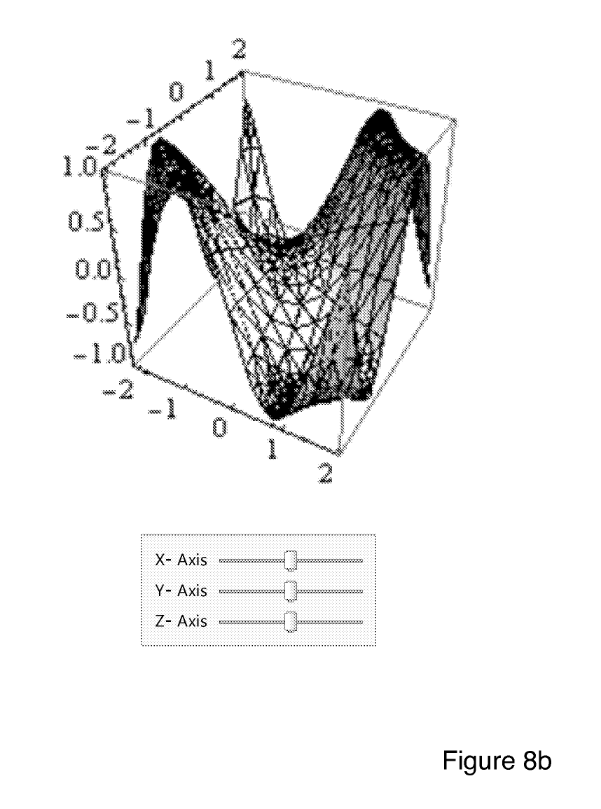

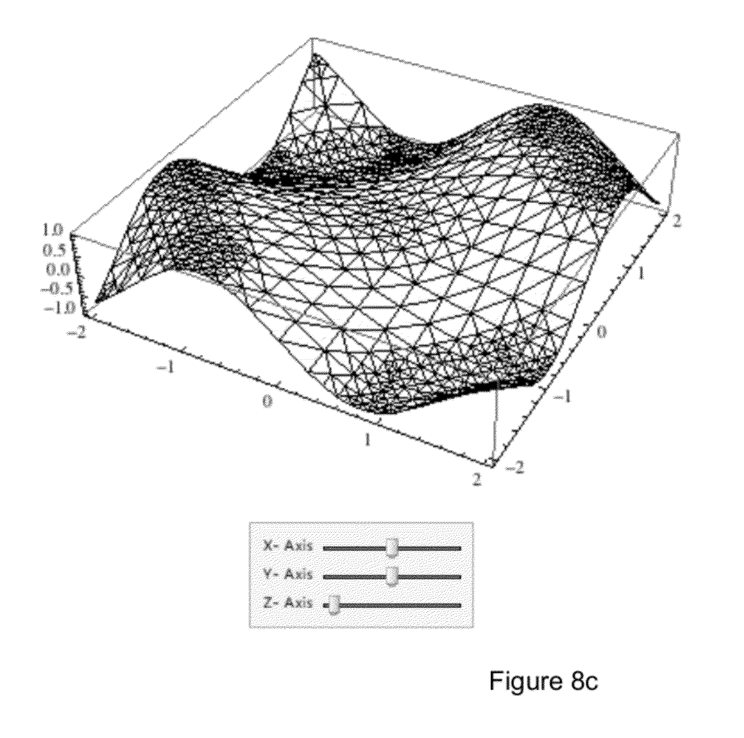

FIGS. 8a-8c show an example user interface experience provided for by the invention wherein the ratio of the selected dimension is adjusted in each direction in the three-dimensional plot. As shown in FIG. 8a, the “X-Axis” slider moved to the left will result in smaller ratio of the X-axis to the rest of the plot. When all the sliders are in neutral position, the ratios of all three dimensions are the same as shown in FIG. 8b. The “Z-Axis” slider is moved to the left will result in smaller ratio of the Z-axis as shown in FIG. 8c.

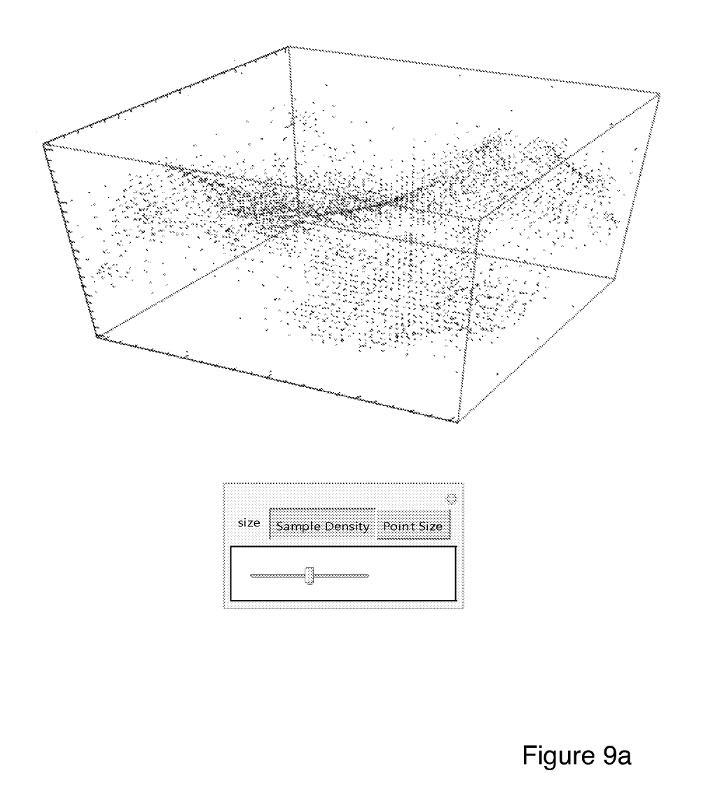

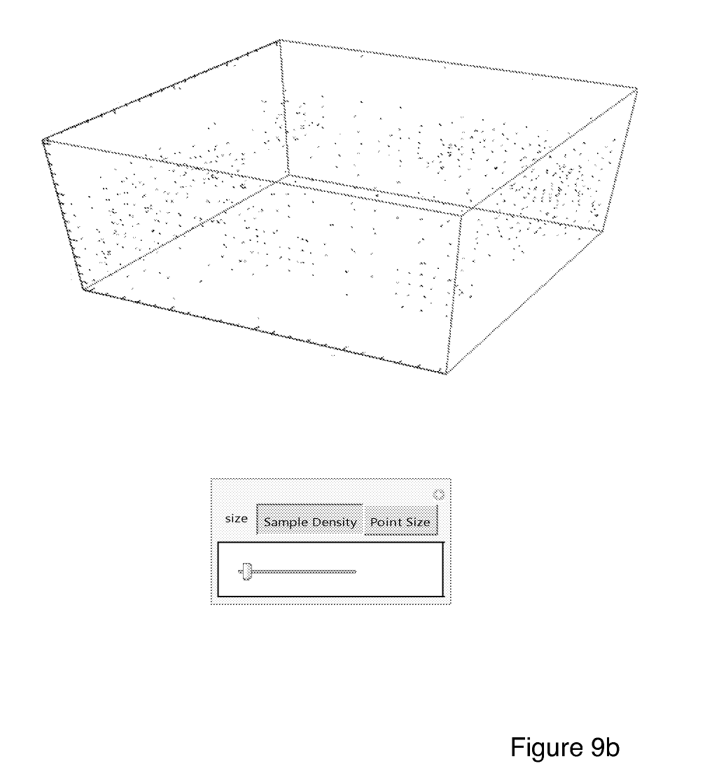

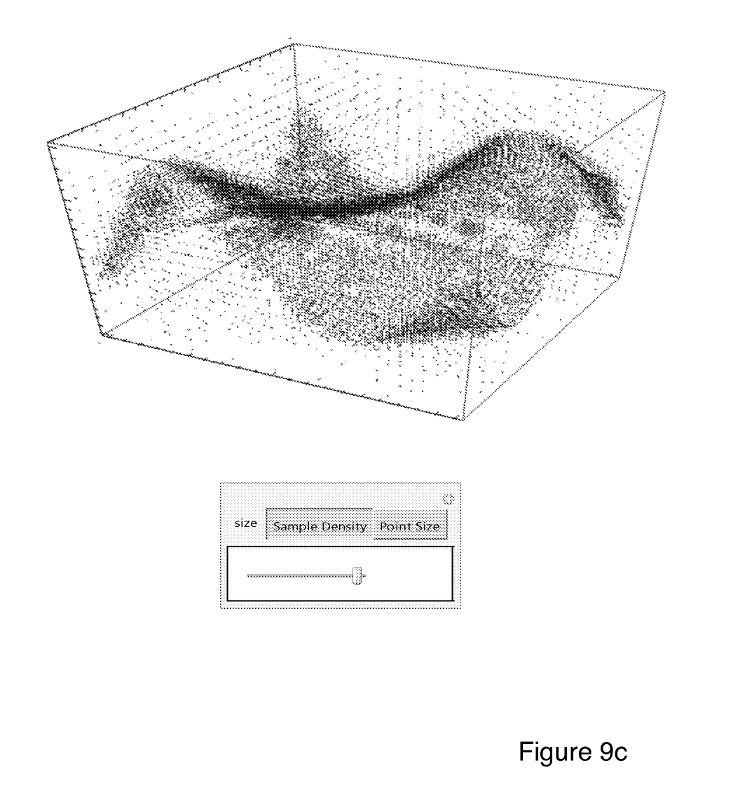

FIGS. 9a-9c show an example user interface experience provided for by the invention wherein the density of the sample points is adjusted in a 3D scatter plot. FIGS. 9a-9c illustrate an example menu and a 3D scatter plot created by Mathematica's ListPointPlot3D function. In an embodiment, clicking in the plot area could invoke such a standard-format menu; other alternatives are of course possible as described earlier and as can be devised by those skilled in the art. In this example, moving the slider to the left while the “Sample Density” option is selected will generate a scatter plot with sparser sample points as shown in FIG. 9b. Moving the slider to the right while the “Sample Density” option is selected will generate a scatter plot with denser sample points as shown in FIG. 9c.

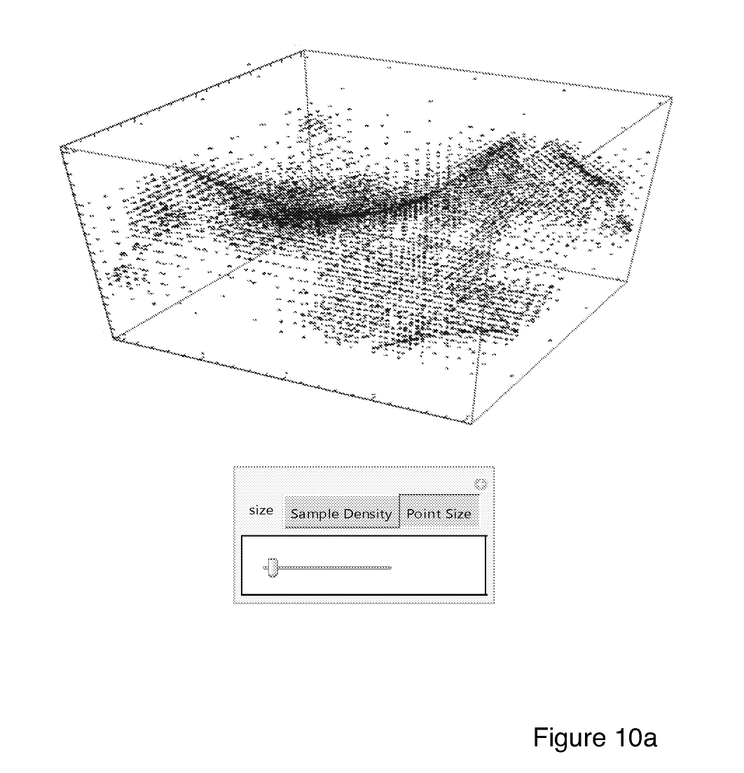

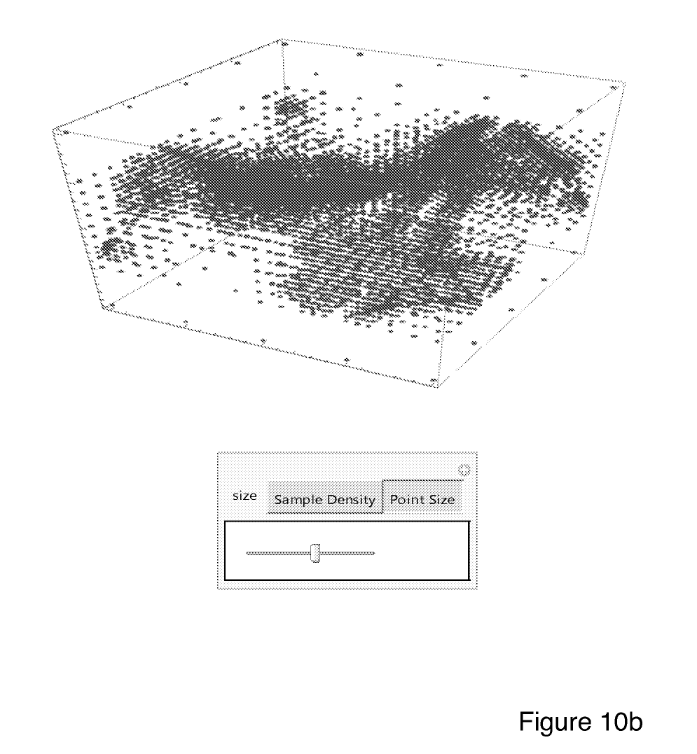

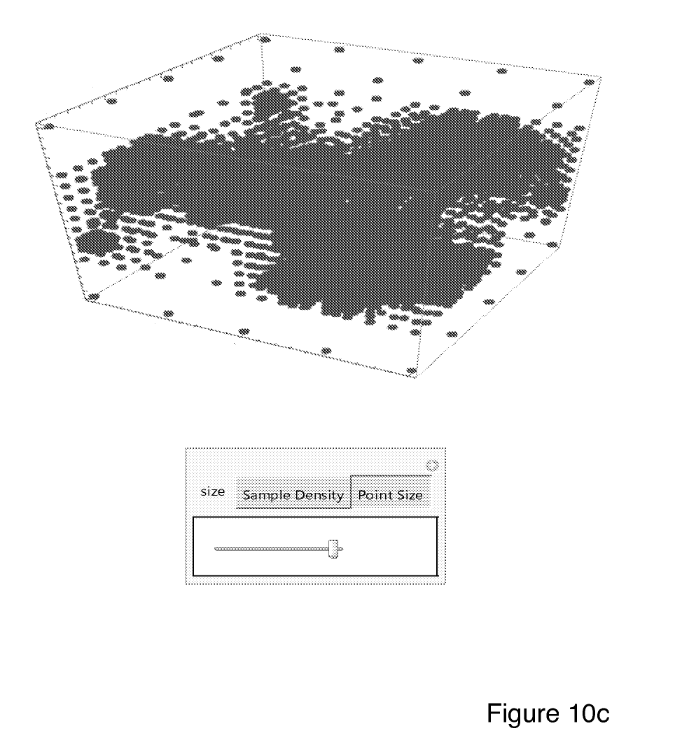

Further as to scatter plots, FIGS. 10a-10c show an example user interface experience provided for by the invention wherein the size of the sample points is adjusted. FIGS. 10a-10c illustrates an example menu and a 3D scatter plot created by Mathematica's ListPointPlot3D function. In this example, moving the slider to the left while the “Point Size” option is selected will decrease the size of sample points (relative to those rendered in FIG. 10a) as shown in FIG. 10a. Moving the slider to the right while the “Point Size” option is selected will increase the size of sample points as shown in FIG. 10c.

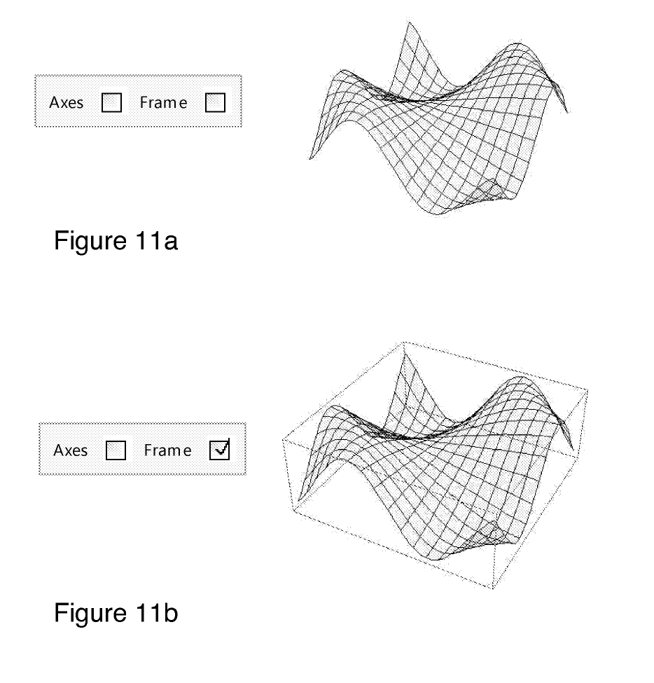

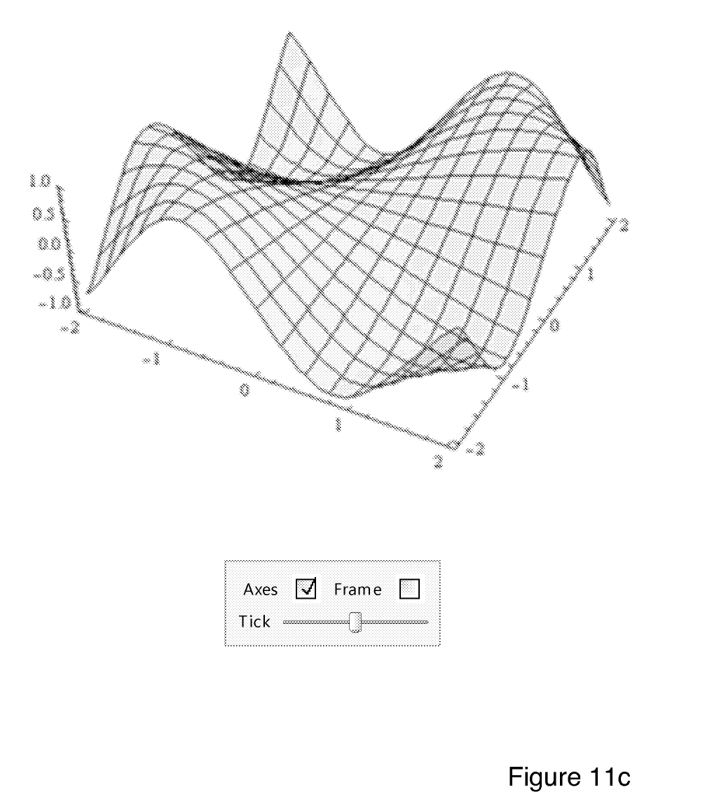

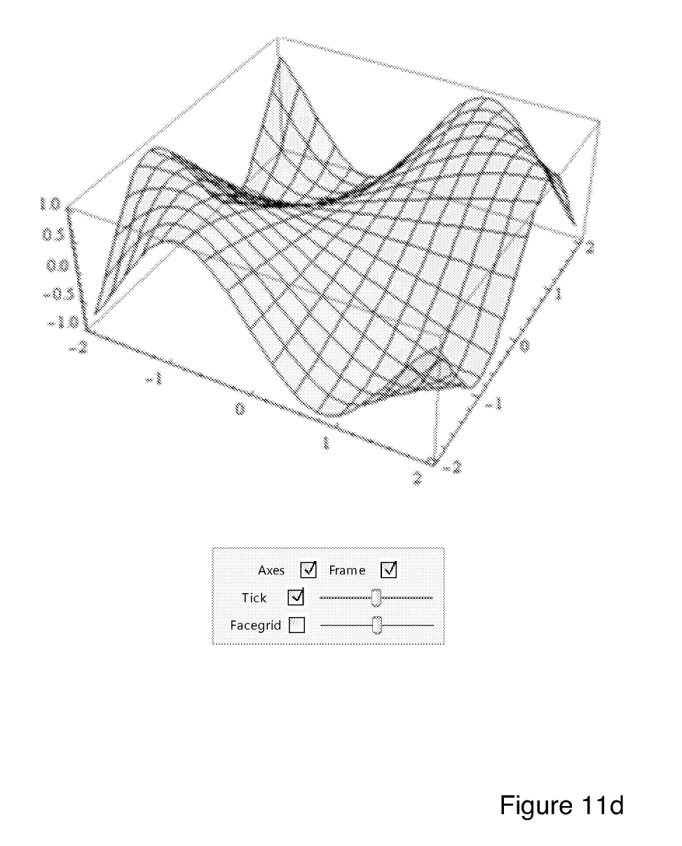

FIGS. 11a-11b show an example user interface experience provided for by the invention wherein the display of axes and frame is turned on/off or adjusted. As shown in FIG. 11a, leaving the “Axes” and “Frame” checkbox unchecked will keep the axes and the frames from being displayed. FIG. 11b is an example wherein the “Frame” checkbox being selected will result in the frames around the 3D plot being displayed. Similarly, FIG. 11c depicts an example wherein the “Axes” checkbox being selected will result in the axes in the 3D plot being displayed. More controls can be added to the menu to manipulate more attributes of the plot. For example, additional sliders that control the density of the tick marks or the face grid are placed in the menu as shown in FIG. 11d.

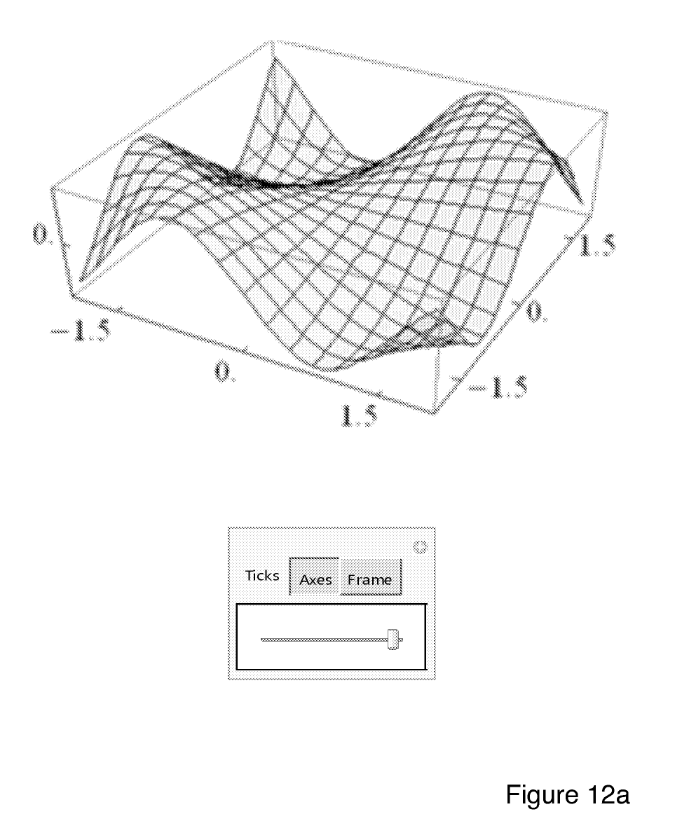

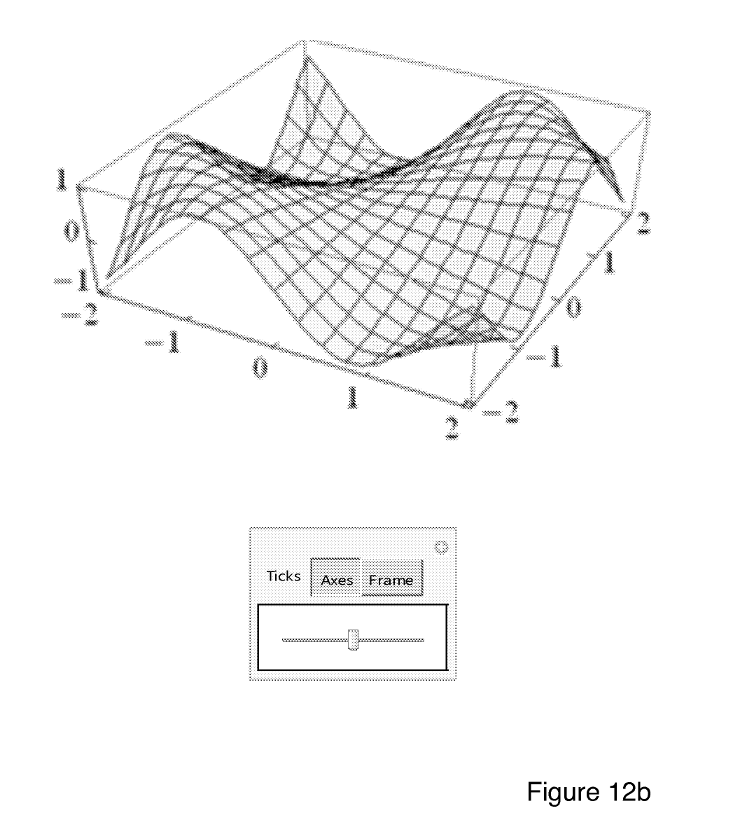

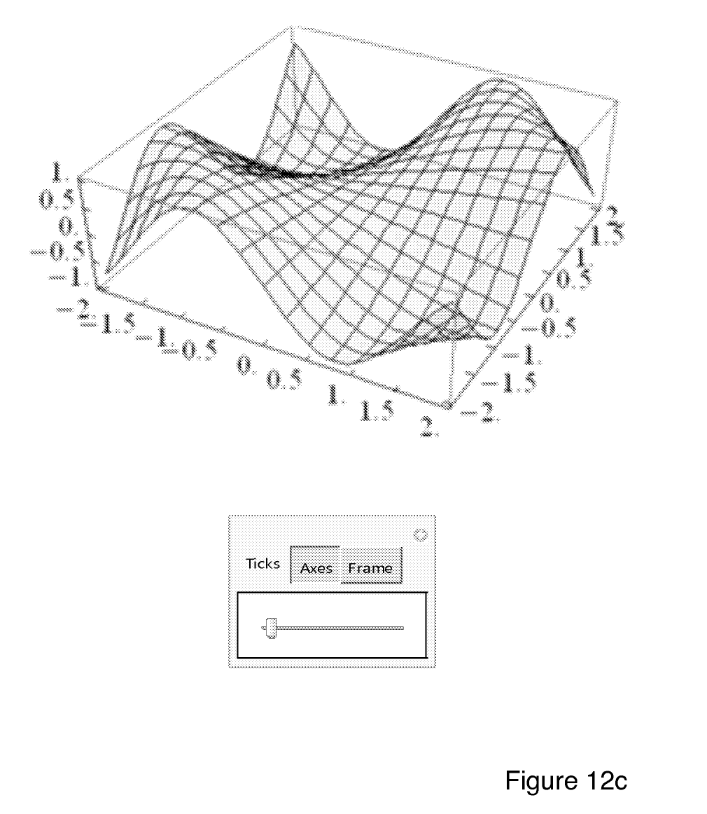

FIGS. 12a-12c show an example user interface experience provided for by the invention wherein the density of the tick marks is adjusted. As shown in FIG. 12a, when the slider is moved to the right, the density of the tick marks is decreased compared to the default setting shown in FIG. 12b. When the slider is moved to the left, the density of the tick marks is increased as shown in FIG. 12c.

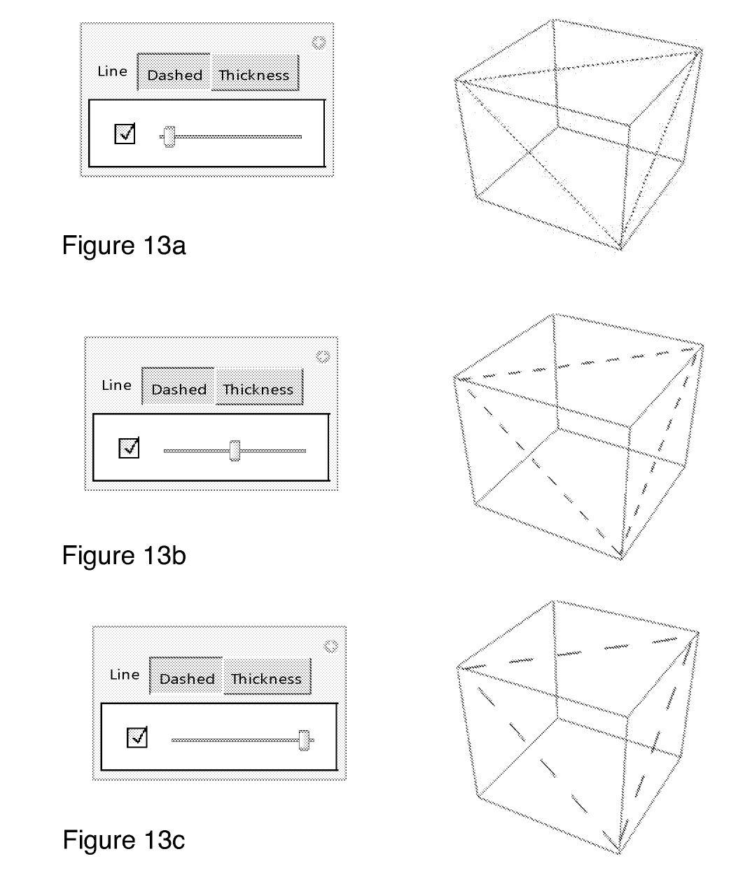

FIGS. 13a-13c show an example user interface experience provided for by the invention wherein the length of the line segments in dashed lines is adjusted. As shown in FIG. 13a, when the slider is moved to the left while the “Dashed” option is selected, the length of the line segments in dashed lines is decreased compared to the default setting shown in FIG. 13b. As shown in FIG. 13c, when the slider is moved to the right, the length of the line segments in dashed lines is increased compared to the default setting shown in FIG. 13b.

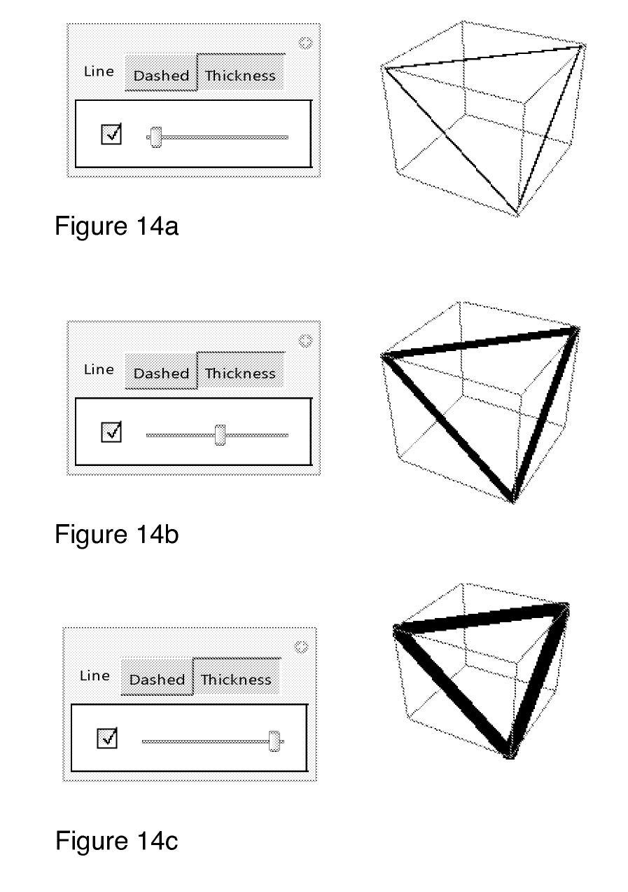

FIGS. 14a-14c show an example user interface experience provided for by the invention wherein the line thickness of the plot is adjusted. As shown in FIG. 14a, when the slider is moved to the left while the “Thickness” option is selected, the thickness of the line in the plot is decreased compared to the default setting shown in FIG. 14b. As shown in FIG. 14c, when the slider is moved to the right, the thickness of the line in the plot is increased.

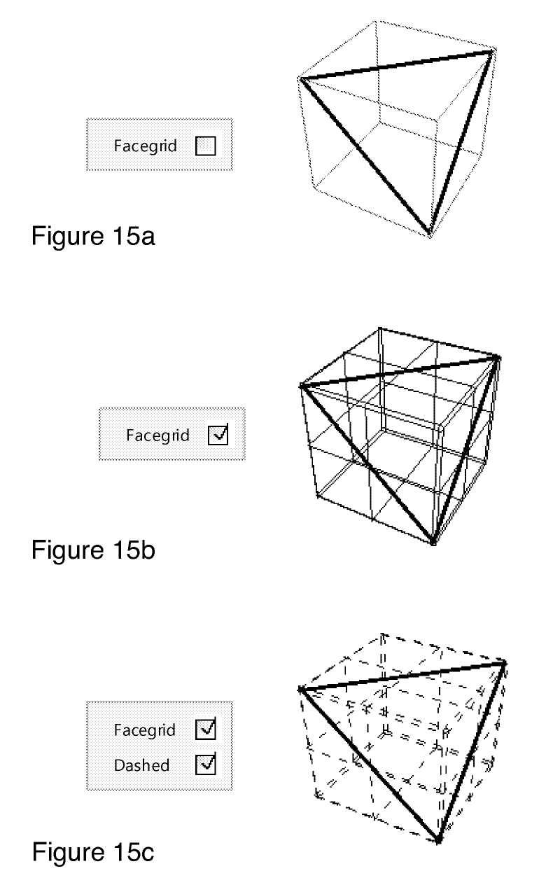

FIGS. 15a-15c show an example user interface experience provided for by the invention wherein whether the face grid lines are displayed is determined by the state of a checkbox. As shown in FIG. 15a, leaving the “Facegrid” checkbox unchecked will keep the grid lines on the frame of the 3D plot hidden. Checking the box will result in the grid lines being displayed as shown in FIG. 15b. In addition, another checkbox control can be added to further control the attributes of the grid lines. In FIG. 15c, “Dashed” checkbox controls whether the grid lines are solid or dashed. Also, similar to the example shown in FIGS. 7b and 7c where the density of the mesh lines on the 3D plot is adjusted with a slider, the attributes of the grid lines, such as density, can also be adjusted with sliders.

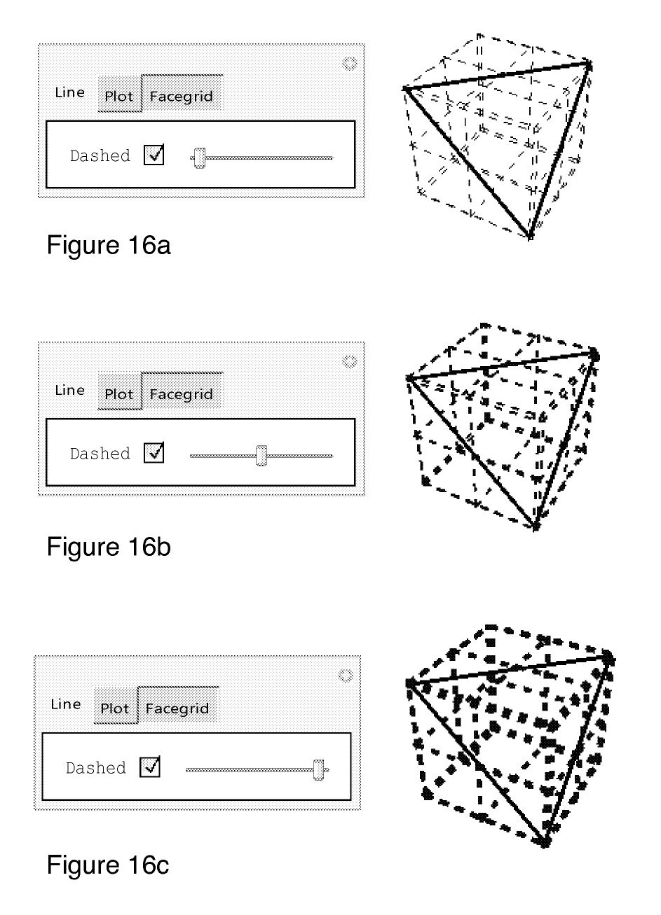

FIGS. 16a-16c show an example user interface experience provided for by the invention wherein the line thickness of the face grid lines is adjusted. As shown in FIG. 16a, when the slider is moved to the left while the “Facegrid” option is selected, the thickness of the grid lines in the frame of the plot is decreased compared to the default setting shown in FIG. 16b. As shown in FIG. 16c, when the slider is moved to the right, the thickness of the grid line is increased.

This short collection of examples provides but a few of thousands of possible that can be provided by the invention. Additional examples of candidate interactive

Some examples of manipulation support “built-in” to mathematical functions within a mathematical programming language, plotting/graphing functions, and representational graphics functions can include but are not limited to:
Axis label text: content, spatial location, orientation, and color;
Axis tick mark separations;
Curve label text: content, spatial location, orientation, and color;
Plot label text: content, spatial location, orientation, and color;
Plot size and aspect ratio(s);
Viewpoint location with respect to the plot;
Curve thickness, dashing, and color;
Meshes and mesh density imposed on a rendered surface;
Scatter plot dot density and dot size;
Color and location of lighting sources for illumination of surface-reflected light;
Light properties (opacity, reflectivity, texture, diffusion pattern) of surfaces, curves, text, axes, etc.;
Scale (linear, log, exponential, conformational, etc.)′
Plot fills under and between curves.

These and additional capabilities can be organized in ways leveraging enhanced interactive 3D and 6D adjustment, for example using advanced input devices such as multiaxis game controllers, the Logitech 3DConnexion SpaceNavigator™, or advanced touch interfaces and touchscreens such as the HDTP technologies described earlier and later. Such interactive 3D and 6D manipulation can be advantageously directed to:
Positions and orientations of 3D object or groups of 3D objects
Viewpoint position;
Lighting source position, color, intensity, etc.;
Label and text spatial location/orientation
Enhanced interactive color (RGB,HSB,YUV) and light property (opacity, reflectivity, texture, diffusion pattern) adjustment of curves and surfaces:
   Objects, plot elements, labels, backgrounds;
   Emitted (“glow”) lighting (color, intensity, etc.);
   Image processing functions;
Enhanced interactive multidimensional object adjustment:
   Spline/surface curvature;
   Plot attributes (grid density, axes ticks, plot-range, etc.);
   Font attributes (type, size, style, color, highlighting).
      Some of these are described in more detail later on in the context of various examples and features provided for by the invention..

### Example User Interface Input Devices

In an embodiment, the interactive WYSIWYG control is responsive to user input from a traditional computer mouse or its equivalents (touchscreens, trackpads, trackballs, etc.).

In an embodiment, the interactive WYSIWYG control is responsive to user input from an advance mouse.

In an embodiment, the interactive WYSIWYG control is responsive to user input from a gesture-based touch interface.

In an embodiment, the interactive WYSIWYG control is responsive to user input from an HDTP or equivalent.

In an embodiment, the user interface device interfaces with the mathematical programming language through use of a USB HID device abstraction. The USB HID device abstraction, originally designed to support items such as computer game controllers, provides:
Platform independence
Interface already in use with game software
Compatibility with wide range of applications supporting Logitech Space Navigator™ “3D mouse” operations

In an embodiment, the interactive WYSIWYG control is responsive to user input provided by the roll angle posture of a finger contacting a touch interface.

In an embodiment, the interactive WYSIWYG control is responsive to user input provided by a gesture comprising a roll angle motion of a finger contacting a touch interface.

In an embodiment, the interactive WYSIWYG control is responsive to user input provided by the pitch angle posture of a finger contacting a touch interface.

In an embodiment, the interactive WYSIWYG control is responsive to user input provided by a gesture comprising a pitch angle motion of a finger contacting a touch interface.

In an embodiment, the interactive WYSIWYG control is responsive to user input provided by the yaw angle posture of a finger contacting a touch interface.

In an embodiment, the interactive WYSIWYG control is responsive to user input provided by a gesture comprising a yaw angle motion of a finger contacting a touch interface.

In an embodiment, the interactive WYSIWYG control is responsive to user input provided by a multiple-finger posture of fingers contacting a touch interface.

In an embodiment, the interactive WYSIWYG control is responsive to user input provided by a gesture comprising changes in the multiple-finger contact with a touch interface.

In an embodiment, the interactive WYSIWYG control is responsive to a tactile grammar interpretation of user input provided by at least one finger contacting a touch interface.

### Example Interactive Adjustment of Color and Light Properties Employing Interactive 3D, 4D, 5D, 6D, or Higher-Dimensional User Input

The invention provides for interactive 3D, 4D, 5D, 6D, or higher-dimensional user adjustment of color and light properties, for example:
Enhanced interactive color (RGB,HSB,YUV color spaces) and light property (opacity, glow, reflectivity, texture, diffusion pattern) adjustment via interactive 3D, 4D, 5D, 6D input for:
   Graphical objects;
   Functions defined on objects;
   Plot elements;
   Backgrounds;
   Lighting;
   Text color, highlight color;
      In some embodiments, enhanced interactivity can be implemented using high numbers of user interface control dimentions. These could be used, for example to interactively adjust more than one color and/or light property can be interactively manipulated simultaneously.

### Example Interactive Adjustment of Light Sources Employing Interactive 3D, 4D, 5D, 6D, or Higher-Dimensional User Input

The invention provides for interactive 3D, 4D, 5D, 6D, or higher-dimensional user adjustment of light sources, for example:
Spatial location of light sources can be manipulated in a way similar to spatial manipulation of objects;
Color of light sources can be manipulated in a way similar to color manipulation of objects;
Enhanced interactivity:
   More than one light source attribute can be interactively manipulated simultaneously
   More than one light source can be interactively manipulated simultaneously

### Example Interactive Adjustment of Other Plot Attributes Employing Interactive 3D, 4D, 5D, 6D, or Higher-Dimensional User Input

The invention provides for interactive 3D, 4D, 5D, 6D, or higher-dimensional user adjustment of various other plot attributes. These can include for example:
Plot range
Plot scaling (linear, log, antilog, log/log, etc.)
Axes labeling (size, location, orientation)
Line thickness
Color assignments / color scheme gradients
Viewpoint and lighting sources (as mentioned earlier)

### Examples of Other Mathematical Operations and Functions for Interactive Capabilities

Additionally, the invention can be broadened to include more of the span depicted in FIG. 1. For example, the invention provides for interactive adjustment of various more general mathematical operations and functions for example:
Statistical operations;
Image processing operations and transformations ;
Geometric transformations (translation operators, rotation operators);
Gestures for non-graphical operations;
   open/collapse parts of notebook within “groups;”
   quickly select and insert functions into notebook using “palettes.”
      In some embodiments, these operations can be introduced where designed in a manner similar to introducing new options to plot commands or functions—for example by clicking, roll-over, menu, dialog box, sliders, buttons, check-boxes, etc. to invoke (and if needed, set parameter values of) the function or operation.

In an embodiment, a programmer could click on a function in the software code and invoke various options on general types of functions via sliders, buttons, check-boxes, etc.

The invention provides for various ways of implementing interactive control of presentation parameters and capabilities. For example:
In an embodiment, the interactivity is directed to interactivity attributes within built-in functions comprised by a mathematical programming language.
In an embodiment, the interactivity attributes within built-in functions comprised by a mathematical programming language are not user selectable.
In an embodiment, the interactivity attributes within built-in functions comprised by a mathematical programming language are user selectable.
   Directing User Input to Specific Plotting, Graphics, and/or Mathematical Functions

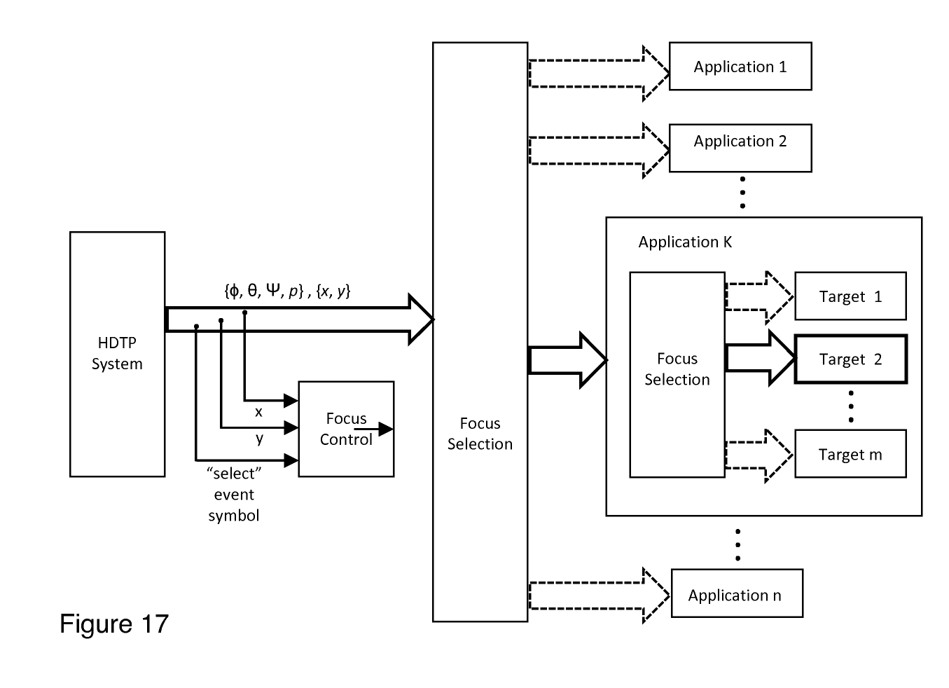

User input can be directed to specific plot attribute, graphics, and/or mathematical functions in a number of ways, with some of this having been described earlier. As to other aspects of this FIG. 17 (adapted from pending U.S. patent application Ser. No. 13/026,248) depicts an arrangement associated with HDTP technology for directing high-dimensional input to specific objects in a particular application on a computer or other system. The arrangement, however, can be used with many types of user interfaces, and need not have the same number or kinds of control information parameters as those depicted in the figure. In general, various levels and/or arrangements of focus selection operations can be employed, the ones depicted in FIG. 17 merely being an example. In various embodiments of the present invention, the overall focus selection operation (however it is implemented) can direct user interface device input information to a particular target, for example any of the plot or other commands, functions, options, operations etc., described thus far as well as others.

### Use of Extended Hypermedia Objects

It is noted that the HDTP technology and other high-dimensional user interface devices such as advanced computer mice can be used to extend the notion of hypermedia objects such as hyperlinks, rollovers, button boxes, sliders, menus, etc. to accept user input comprising user-adjustable values, as taught in for example pending U.S. patent application Ser. No. 13/026,248. The present invention provides for the use of such extended hypermedia objects as user input devices to control the interactive features described thus far and in the additional material that follows.

In various embodiments of the invention, the for the use of such extended hypermedia objects can be implemented as part of the graphics output rendered by the visualization software, rendered either as an application display window, screen output, or directed to a web browser supporting these features.

In the case of a web browser, the for the use of such extended hypermedia objects can be used to control browser and/or web-based visualization applications, including server-hosted visualization applications, distributed implementation visualization applications, cloud-based visualization applications, and other variations and alternative implementations.

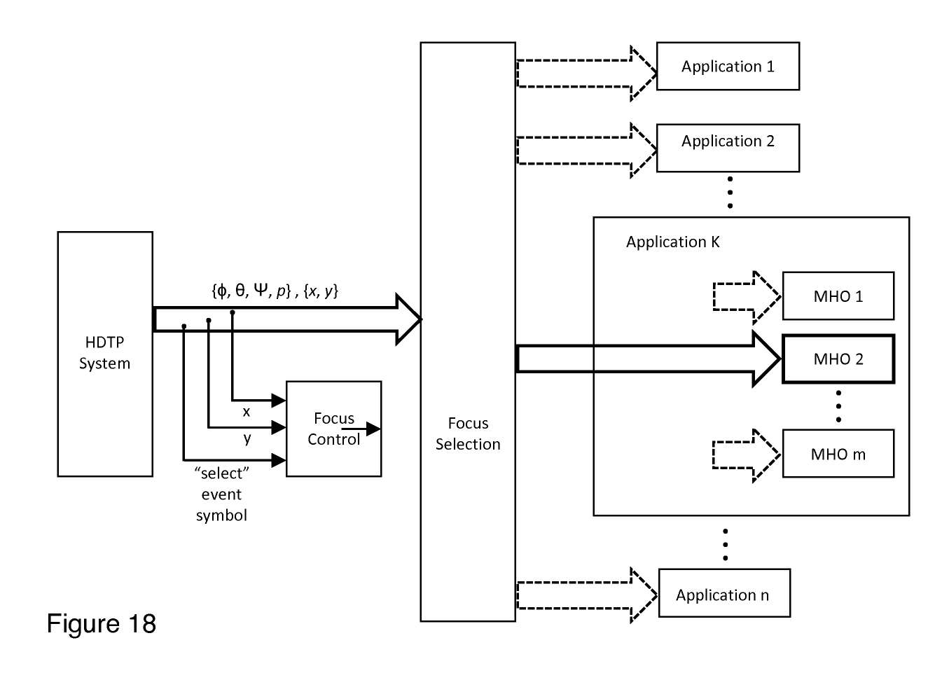

FIG. 18 (adapted from pending U.S. patent application Ser. No. 13/026,248) depicts what here could be viewed as a variation of FIG. 17 in which the targets of FIG. 17 are extended hyperlink objects (referred to as “Multiparameter Hypermedia Objects,” or “MHOs,” in pending U.S. patent application Ser. No. 13/026,248.

### User Interaction Event Algorithms

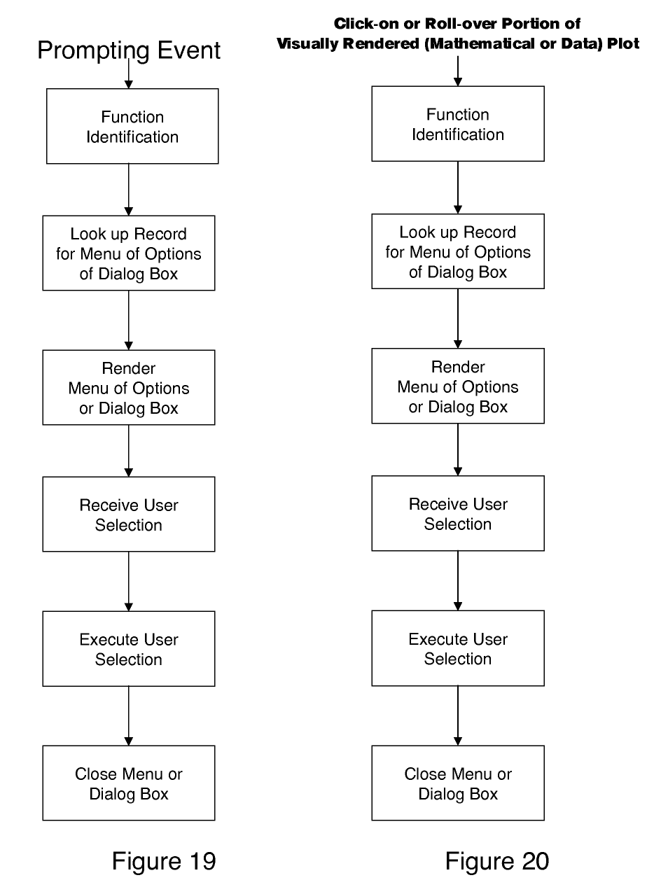

FIG. 19 depicts an example flow chart for directing user input to specific plotting, graphics, and/or mathematical functions. A prompting event (for example:
a selection event from a menu, dialog box, or button box,
clicking on a portion of a plot or graphics rendering,
a rollover on a portion of a plot or graphics rendering,
   leads to the identification of a function to which to direct interactive user interface control. In this example, the identification of the function leads to looking up a stored record for menu option entries, dialog box entries, etc. Alternatively other approaches can be used, but once any of these receive a user selection event the user section is executed and the menu, dialog box, or alternative implementation closes. Other approaches are indeed possible and are anticipated by the invention.

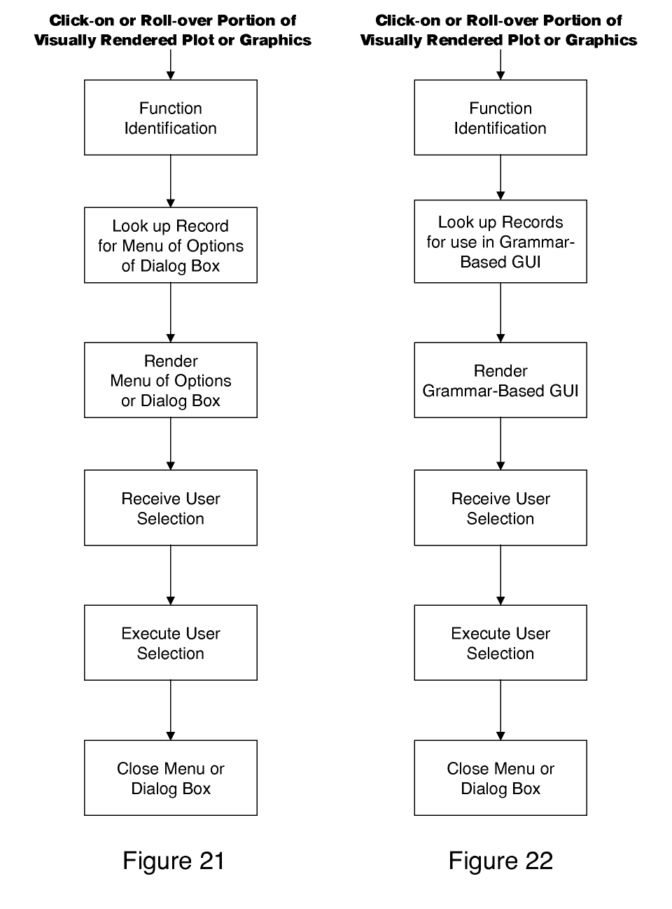

Consider the case where the prompting event is a click-on or roll-over vent. FIG. 20 illustrates an example wherein click-on or roll-over event occurs on a portion of a visually rendered mathematical or data plot. The visually rendered mathematical or data plot can be simple or complex, comprise two or three dimensions, comprise labels, colors, symbols, textures, etc. FIG. 21 illustrates an example wherein click-on or roll-over event occurs on a portion of a visually rendered graphical representation. The visually rendered graphical representation can be simple or complex, comprise two or three dimensions, comprise labels, colors, symbols, textures, etc.

In an embodiment, the interactivity is directed to specific built-in functions comprised by a mathematical programming language as a result of the user making a menu selection from a menu of options.

In an embodiment, the menu of options comprises a list that is dynamically generated responsive to specific built-in functions used in a user program.

In an embodiment, the interactivity is directed to specific built-in functions comprised by a mathematical programming language as a result of the user clicking-on or rolling-over a portion of a visually-rendered mathematical plot.

In an embodiment, the interactivity is directed to specific built-in functions comprised by a mathematical programming language as a result of the user clicking-on or rolling-over a portion of a visually-rendered data plot.

In an embodiment, the interactivity is directed to specific built-in functions comprised by a mathematical programming language as a result of the user clicking-on or rolling-over a portion of a visually-rendered graphical representation of mathematically-produced data.

In an embodiment, the interactivity is directed to specific built-in functions comprised by a mathematical programming language as a result of the user clicking-on or rolling-over a portion of a visually-rendered graphical representation of measurement data.

In an embodiment, the interactivity is directed to specific built-in functions comprised by a mathematical programming language as a result of the user clicking-on or rolling-over a portion of a visually-rendered graphical representation of mathematically processed measurement data.

In an embodiment, the interactivity is directed to specific built-in functions comprised by a mathematical programming language as a result of the user manipulating a user interface grammar. An example of a user interface grammar is any of a collection of possible tactile grammars such as those implemented by or supported by various types of HDTP embodiments and taught, for example, in U.S. Pat. No. 6,570,078 and U.S. patent application Ser. No. 11/761,978 and U.S. Ser. No. 12/418,605, among others).

### User Interface Input Modalities, Metaphors, Gestures, and Grammars

It is noted that the HDTP technology comprises many touch-based linguistics features including rich touch-based metaphors and touch-based grammars as taught for example in U.S. Pat. No. 6,570,078, pending U.S. patent application Ser. No. 11/761,978, pending U.S. patent application Ser. No. 12/418,605, pending U.S. Patent Application 61/449,923, pending U.S. Patent Application 61/482,248, pending U.S. Patent Application 61/482,606, and pending U.S. Patent Application 61/567,626. These touch-based linguistics features including rich touch-based metaphors and touch-based grammars can operate with conventional touchpads, touchscreens, and other user input devices as taught in in U.S. Pat. No. 6,570,078 the pending U.S. Patent applications listed above.

Additionally, it is noted that the HDTP technology can be adapted to convey such information over a physical or virtual Universal Serial Bus (USB) link to a host computer, workstation, or other device employing for example the USB Human Interface Device (HID) conventions, descriptors, and protocols as taught for example in pending U.S. patent application Ser. No. 13/356,578. In the latter arrangement, the HDTP technology can be configured to appear both as a touch-based linguistics user-interface device as well as a higher-accuracy, higher-ease-of-use emulation of 3D and 6D user-interface devices such as the Logitech 3DConnexion SpaceNavigator™ or various established USB HID Multiaxis game controllers. It is noted that both the Logitech 3DConnexion SpaceNavigator™ and such established USB HID “Multi-axis game controllers” are, for example, already supported by Mathematica for use in real-time control, and Mathematica can be already readily configured by users to respond to other USB HID information channels carrying binary-valued and byte-valued control signals. Additionally, U.S. patent application Ser. No. 13/356,578 more generally teaches the transport of touch-based linguistics features including rich touch-based metaphors and touch-based grammars over USB HID protocol.

The present invention provides for touch-based linguistics features including rich touch-based metaphors and touch-based grammars to be used as user input devices to control the interactive features described thus far and in the additional material that follows. In various embodiments of the invention, the touch-based linguistics features including rich touch-based metaphors and touch-based grammars can be implemented internally within the computer or other device operating the visualization software, can be carried over a USB connection between a peripheral HDTP device and a hosting computer or other device operating the visualization software, and/or directed to a web browser supporting these features. In the case of a web browser, the touch-based linguistics features including rich touch-based metaphors and touch-based grammars can be used to control browser and/or web-based visualization applications, including server-hosted visualization applications, distributed implementation visualization applications, cloud-based visualization applications, and other variations and alternative implementations.

FIG. 22 depicts and example adaption of the flow charts depicted in FIG. 20 and FIG. 21 where grammar-based GUIs are used to create environments for user selection and specification.

The invention further provides for the role of context and changes in context as taught, for example, in U.S. Pat. No. 6,570,078 and U.S. patent application Ser. No. 11/761,978, pending U.S. patent application Ser. No. 12/418,605, and pending U.S. Patent Application 61/482,248, among others). For example, in various embodiments, context can be used to change touch-interface modalities among various modes, for example:
Linguistic/parameterized gesture modes
Interactive 6D-input modes
6D-data-entry modes

There are many possible approaches—for example:
Selected finger used for 6D data conveyance
One or more other associated fingers used for
   Mode-change operations
   “enter” capture operations
   “out-of-band” linguistic gestures
   Additional parameters
      Note that the above (or alternatives) can be replicated for multiple simultaneous data-entry modes.

The aforementioned, as well as other variations, can be implemented as an algorithm on a digital computer, embedded processor, signal processor, or combination of two or more of these.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

While the invention has been described in detail with reference to disclosed embodiments, various modifications within the scope of the invention will be apparent to those of ordinary skill in this technological field. It is to be appreciated that features described with respect to one embodiment typically can be applied to other embodiments.

The invention can be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

Although exemplary embodiments have been provided in detail, various changes, substitutions and alternations could be made thereto without departing from spirit and scope of the disclosed subject matter as defined by the appended claims. Variations described for the embodiments may be realized in any combination desirable for each particular application. Thus particular limitations and embodiment enhancements described herein, which may have particular advantages to a particular application, need not be used for all applications. Also, not all limitations need be implemented in methods, systems, and apparatuses including one or more concepts described with relation to the provided embodiments. Therefore, the invention properly is to be construed with reference to the claims.

I claim:

1. A method for providing interactive adjustment of plot and data visualization through rapid user-machine interaction, the method comprising:
rendering a first graphical representation of provided data on a display screen;
receiving first user interface information from a user interface device;
associating the information with an aspect of the graphical representation of provided data;
upon a selection event, directing second user interface information from a user interface device to a graphical rendering function associated with the aspect of the graphical representation of data, the graphical rendering function having an existing value;
using the second user interface information to change the existing value of the graphical rendering function to a new value responsive to second user interface information; and
replacing the first graphical representation of provided data on the display screen with a second graphical representation of provided data;
wherein the second graphical representation of provided data is responsive to second user interface information from a user interface device.
